(19) United States
(12) Patent Application Publication
(10) Pub. No.: US 2003/0073494 A1
(43) Pub. Date: Apr. 17, 2003

(54) Gaming methods, apparatus, media and signals

(76) Inventors: Jacob H. Kalpakian, Vancouver (CA); Donald Brian Hunter, Mississauga (CA)

Correspondence Address: DOWELL & DOWELL, P.C., Ralph A. Dowell, Suite 309, 1215 Jefferson Davis Highway, Arlington, VA, 22202, US

(21) Appl. No.: 09/976,017

(22) Filed: Oct. 15, 2001

(51) Int. Cl. A63F 13/00

(52) U.S. Cl. 463/42; 463/11; 463/12; 463/13; 463/16

(57) ABSTRACT

Gaming methods, apparatuses, media and signals are disclosed. One such method involves automatically determining, in response to a performance indicator indicative of performance of a player in one hand of a game, an ante amount for the player for a subsequent hand of the game. Another such method involves receiving game status signals from a game server and communicating game decision signals to the game server, to enable a player to play one hand of a game and to enable the player to play a subsequent hand of the game for which an ante amount for the player is automatically determined in response to performance of the player in the one hand of the game.

### BACKGROUND OF THE INVENTION

1. Field of Invention

The present invention relates to gaming, and more particularly to gaming methods, apparatuses, media and signals.

2. Description of Related Art

The popularity of gaming, such as on-line gaming, for example, has increased in tandem with the rapid growth of Internet use over the last decade. Web sites offering on-line gaming have provided players with opportunities to wager real money with players from around the world in games played against a common opponent, such as a house or an automated dealer for example. Now available on-line gaming web sites number in the thousands.

The gaming industry has realized that it must continue to foster the development of new games and concepts in order to hold and attract a greater number of players. One of the avenues pursued by the gaming industry is to make existing on-line games more interesting and challenging, with greater potential pay-outs to players, and to liven the pace of traditionally slow games, such as poker for example, where players must make a series of decisions and are dealt of number of cards before the completion of each hand.

Only a handful of existing web sites offers players the opportunity to wager money in real-time play against each other. This gives players an added excitement of competition and the opportunity to display and hone card playing skills against real opponents. Most of these sites offer traditional games of poker, which involve some skill and strategy in playing each game. Other types of games, such as Keno or Bingo, do not necessarily allow players to play against each other.

Players of on-line games often face disadvantages which discourage on-line play. In certain cases, when players are equally matched, it may take several hours of game play before a player may accumulate significant winnings. This increases the prevalence of boredom that discourages repeated playing.

Conventional games are typically played in hands in which wagers of one hand are decoupled from wagers in a subsequent hand. Each cumulative pot is doled out to the winner(s) at the end of each hand and the subsequent hand starts anew. Therefore the drama of playing a hand ends once a winner of the hand is determined. There is typically no mechanism by which pots can be progressively accumulated from hand to hand, allowing for potential larger pay-outs to winners.

Therefore, there is a need for an improved gaming method and apparatus.

### SUMMARY OF THE INVENTION

The present invention addresses the above need by providing, in accordance with one aspect of the invention, a gaming method involving automatically determining, in response to a performance indicator indicative of performance of a player in one hand of a game, an ante amount for the player for a subsequent hand of the game.

In specific embodiments of such an invention, because the performance of the player in one hand of the game is used to determine an ante amount for the player for a subsequent hand of the game, the potential exists for the “pot” to substantially increase through successive hands of the game, thereby allowing progressively higher stakes gaming with each successive hand, if desired. In addition, because the ante amount for the subsequent hand is automatically determined, it is not necessary for players to waste time manually calculating the required ante amount in response to the performance indicator, and therefore, the pace of the game, and thus its excitement level, may be increased if desired.

The method may further involve permitting the player to play the one hand only if the player has available funds of at least a maximum possible value of the ante amount for the subsequent hand. This may involve calculating the maximum possible value of the ante amount for the subsequent hand, and comparing the maximum possible value to account record contents indicative of the available funds of the player. Advantageously, therefore, in such an embodiment, a player may be prevented from playing a given hand if the player does not have sufficient funds to cover his or her maximum possible ante amount for the next hand.

The method may also involve selecting a payment process for the ante amount in response to the indicator. This may involve automatically debiting the ante amount for the subsequent hand if the indicator indicates a predefined performance of the player in the one hand. Automatically debiting the ante amount may occur only if the performance indicator indicates a loss by the player in the one hand, and may occur prior to a commencement of the subsequent hand. Advantageously, therefore, in such an embodiment, a player who has decided to remain in and has lost a given hand, cannot deprive other players of the benefit of the player's automatically determined ante amount for the subsequent hand, as the player's ante amount for the subsequent hand is automatically debited before the subsequent hand commences, regardless of whether the player chooses to actually play the subsequent hand.

Either or both of the above optional approaches may be employed to reduce or eliminate the likelihood that a given player may attempt to play one hand of the game, even if the player does not have sufficient funds to cover the maximum ante amount for the subsequent hand that may be automatically determined in response to the performance parameter indicative of the player's performance in the one hand of the game.

The method also may involve prompting the player to authorize payment of the ante amount if the indicator indicates a predefined performance by the player in the one hand. More particularly, this may involve prompting the player if the indicator indicates a fold or a win by the player in the one hand. The method may also involve waiving payment of the ante amount if the indicator indicates a predefined performance of the player in the one hand. In this regard, the payment of the ante amount may be waived if the indicator indicates a win by the player in the one hand, for example.

The method may further involve automatically determining the ante amount as a function of a pot of the one hand if the indicator indicates a predefined performance of the player in the one hand. For example, this may involve setting the ante amount equal to the pot if the indicator indicates a loss by the player in the one hand.

Alternatively, or in addition, the method may involve setting the ante amount equal to a predefined value if the indicator indicates a predefined performance, such as a win or a fold of the player in the one hand.

The method may further involve receiving a request from a new player to join the game, and permitting the new player to join the game only when a round of the game has ended. Advantageously, this may prevent the new player from taking advantage of large accumulations in the pot contributed by existing players during previous hands of the round, with no risk or contribution from the new player. In this regard, the method may involve maintaining a round indicator indicative of whether the round of the game is in progress, and may further involve setting the round indicator active at a commencement of a first state of the game. In addition, for each hand of the game, the method may also involve resetting the round indicator inactive if a round-terminating condition has occurred, to indicate the round has ended. This may further involve monitoring the performance indicator for each player of the game to determine whether the round-terminating condition has occurred. The round-terminating condition may occur if there are no losers and at least one winner of the game.

The method may also involve generating and storing the performance indicator. The performance indicator may be generated to indicate a fold by the player in response to a fold command received from the player, for example.

The method may further involve automatically determining, in response to a plurality of performance indicators indicative of performance of a plurality of respective players in one hand of a game, an ante amount for each of the players for a subsequent hand of the game. In this case, the method may further involve simultaneously notifying the players of in decisions and fold decisions of all of the players.

In accordance with another aspect of the invention there is provided a gaming method involving receiving game status signals from a game server and communicating game decision signals to the game server, to enable a player to play one hand of a game and to enable the player to play a subsequent hand of the game for which an ante amount for the player is automatically determined in response to performance of the player in the one hand of the game.

In accordance with another aspect of the invention there is provided a gaming apparatus including a processor circuit configured to automatically determine, in response to a performance indicator indicative of performance of a player in one hand of a game, an ante amount for the player for a subsequent hand of the game.

The apparatus may further include a memory device in communication with the processor circuit, which may be configured to generate and store the performance indicator in the memory device.

More generally, the processor circuit may be further configured to carry out the various methods described herein, if desired.

In accordance with another aspect of the invention there is provided a gaming apparatus including a processor circuit configured to receive game status signals from a game server and to communicate game decision signals to the game server, to enable a player to play one hand of a game and to enable the player to play a subsequent hand of the game for which an ante amount for the player is automatically determined in response to performance of the player in the one hand of the game.

In accordance with another aspect of the invention there is provided a gaming apparatus including means for associating with a player, a performance indicator indicative of performance of the player in one hand of a game, and means for automatically determining an ante amount for the player for a subsequent hand of the game, in response to the indicator.

In accordance with another aspect of the invention there is provided a gaming apparatus including means for receiving game status signals from a game server and means for communicating game decision signals to the game server, to enable a player to play one hand of a game and to enable the player to play a subsequent hand of the game for which an ante amount for the player is automatically determined in response to performance of the player in the one hand of the game.

In accordance with another aspect of the invention there is provided a computer-readable medium storing codes for directing a processor circuit to automatically determine, in response to a performance indicator indicative of performance of a player in one hand of a game, an ante amount for the player for a subsequent hand of the game.

In accordance with another aspect of the invention there is provided a computer-readable medium storing codes for directing a processor circuit to receive game status signals from a game server and to communicate game decision signals to the game server, to enable a player to play one hand of a game and to enable the player to play a subsequent hand of the game for which an ante amount for the player is automatically determined in response to performance of the player in the one hand of the game.

In accordance with another aspect of the invention there is provided a signal including a code segment for directing a processor circuit to automatically determine, in response to a performance indicator indicative of performance of a player in one hand of a game, an ante amount for the player for a subsequent hand of the game.

In accordance with another aspect of the invention there is provided a signal including a first code segment for directing a processor circuit to receive game status signals from a game server and a second code segment for directing the processor circuit to communicate game decision signals to the game server, to enable a player to play one hand of a game and to enable the player to play a subsequent hand of the game for which an ante amount for the player is automatically determined in response to performance of the player in the one hand of the game.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of a gaming apparatus, according to a first embodiment of the invention;

FIG. 2 is a block diagram of a gaming apparatus, according to a second embodiment of the invention;

FIG. 3 is a block diagram of a game server of the apparatus shown in FIG. 2;

FIG. 4 is a tabular representation of a user table used by a processor circuit shown in FIG. 3 of the game server shown in FIG. 2;

FIG. 5 is a tabular representation of a user game table used by the processor circuit shown in FIG. 3;

FIG. 6 is a tabular representation of a games table used by the processor circuit shown in FIG. 3;

FIG. 7 is a tabular representation of a game configuration table used by the processor circuit shown in FIG. 3;

FIG. 8 is a tabular representation of a hand summary table used by the processor circuit shown in FIG. 3;

FIG. 9 is a tabular representation of a hand details table used by the processor circuit shown in FIG. 3;

FIG. 10 is a tabular representation of a house values table maintained by the processor circuit shown in FIG. 3;

FIG. 11 is a tabular representation of a user session object generated and used by the processor circuit shown in FIG. 3;

FIG. 12 is a tabular representation of a player session object generated and used by the processor circuit shown in FIG. 3;

FIG. 13 is a tabular representation of a game object generated and used by the processor circuit shown in FIG. 3;

FIG. 14 is a tabular representation of a waiter object generated and used by the processor circuit shown in FIG. 3;

FIG. 15 is a tabular representation of a transaction log maintained by the processor circuit shown in FIG. 3;

FIG. 16 is a tabular representation of a connection log maintained by the processor circuit shown in FIG. 3;

FIG. 17 is a tabular representation of a session log maintained by the processor circuit shown in FIG. 3;

FIG. 18 is a flowchart of a web server routine executed by the processor circuit shown in FIG. 3;

FIG. 19 is a flowchart of a Java application server routine executed by the processor circuit shown in FIG. 3;

FIG. 20 is a flowchart of a game server routine executed by the processor circuit shown in FIG. 3;

FIG. 21 is a flowchart of a user session object options routine executed by the processor circuit shown in FIG. 3;

FIG. 22 is a flowchart of a player session object options routine executed by the processor circuit shown in FIG. 3;

FIG. 23 is a flowchart of a wait watcher routine executed by the processor circuit shown in FIG. 3;

FIGS. 24A and 24B are a flowchart of a game object game routine executed by the processor circuit shown in FIG. 3; and

FIG. 25 is a flowchart of a client game applet routine executed by a processor circuit of a client shown in FIG. 2.

### DETAILED DESCRIPTION

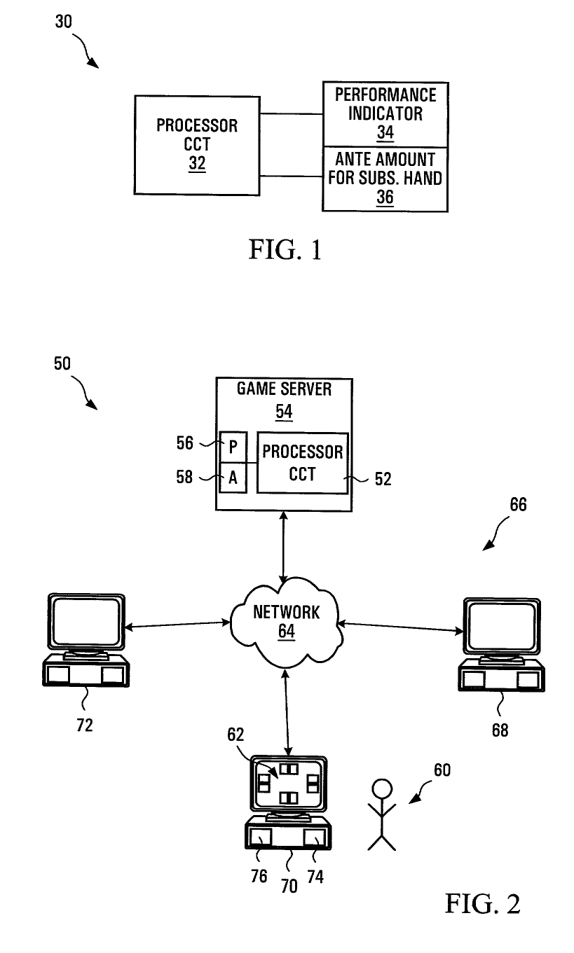

Referring to FIG. 1, a gaming apparatus according to a first embodiment of the invention is shown generally at 30. The apparatus includes a processor circuit 32, configured to automatically determine, in response to a performance indicator 34 indicative of performance of a player in one hand of a game, an ante amount 36 for the player for a subsequent hand of the game.

Network Embodiment

Referring to FIG. 2, a gaming apparatus according to a second embodiment of the invention is shown generally at 50. The apparatus includes a processor circuit 52, which in this embodiment is provided within a game server 54. The processor circuit 52 is configured to automatically determine, in response to a performance indicator 56 indicative of performance of a player in one hand of a game, an ante amount 58 for the player for a subsequent hand of the game. More particularly, in this embodiment, the performance indicator 56 is indicative of a win, a loss or a fold, by a player such as that shown at 60 for example, in one hand of a game such as that shown at 62 for example, and the processor circuit 52 is configured to automatically determine the ante amount 58 for player 60 for the next successive hand of the game 62, in response to the performance indicator 56. More particularly still, in this embodiment the game is guts poker. Alternatively, other types of games, or other performance indicators, may be substituted.

In this embodiment, the processor circuit 52 of the game server 54 is in communication with a network 64, which in this embodiment is the Internet. Alternatively, other networks, such as public or private local- or wide-area networks for example, may be substituted. For example, embodiments of the invention may be implemented using wireless communications such as satellite communications, or wired communications such as cable networks for example. Similarly, any other type of digital media may be substituted, for example.

In the present embodiment the processor circuit 52 of the game server 54 is in further communication with a plurality of clients shown generally at 66, such as client computers 68, 70 and 72, for example. In this embodiment each of the clients includes a local client processor circuit such as that shown at 74 for example, configured to receive game status signals from the game server 54 and to communicate game decision signals to the game server, to enable a player such as the player 60 to play one hand of a game such as the game 62, and to enable the player to play a subsequent hand of the game for which an ante amount (in this embodiment the ante amount 58) for the player is automatically determined in response to performance of the player in the one hand of the game. Each client further includes a computer-readable medium, such as a hard disk drive 76 for example, for storing codes for directing the processor circuit of the client to communicate with the game server as described above. Each client may receive, via either the network 64 or from a local computer-readable medium reading device for example, a signal including respective code segments for directing the processor circuit of the client to communicate with the game server in the above manners.

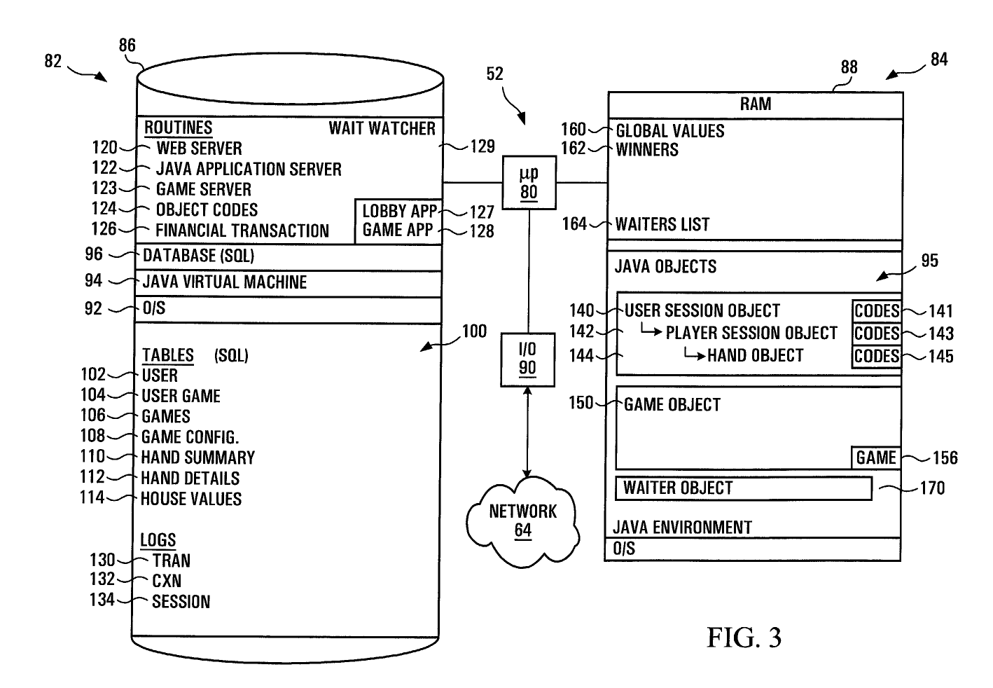

Referring to FIG. 3, the processor circuit of the game server 54 is shown generally at 52. In this embodiment, the processor circuit includes a microprocessor 80, which in this embodiment is an Intel Pentium-4™ microprocessor. More generally, however, in this specification including the claims, the term “processor circuit” is intended to broadly include any type of device capable of processing data signals for the purposes described herein, including (without limitation) other types of microprocessors, microcontrollers, other integrated circuits, other types of circuits or combinations of circuits, logic gates or gate arrays, or programmable devices of any sort, either alone or in combination with other such devices located at the same location or remotely from each other, for example.

The microprocessor 80 in the present embodiment is in communication with first and second memory devices 82 and 84, which in this embodiment include a hard disk drive 86 and a random access memory (RAM) 88 respectively. The microprocessor 80 is in further communication with the network 64 shown in FIG. 2, via an input/output (I/O) interface 90. In the present embodiment, the processor circuit 52 is configured to generate and store the performance indicator in the second memory device 84, as discussed in greater detail below.

In this embodiment the hard disk drive 86 stores a plurality of software programs and routines for configuring the processor circuit 52 to perform the functionality described herein. More particularly, in this embodiment the hard disk drive includes an operating system store 92 for storing an operating system, and a Java™ Virtual Machine (JVM) store 94, for storing codes representing a Java Virtual Machine for execution by the processor circuit 52 to provide a Java environment 95.

In the present embodiment the hard disk drive 86 further includes a database software store 96, for storing codes for directing the processor circuit 52 to maintain a database shown generally at 100, which in this embodiment includes a Microsoft™ SQL database.

The hard disk drive 86 of the present embodiment further stores a web server routine 120 and a Java application server routine 122, which in this embodiment include a Microsoft Internet Information Server (IIS) routine and a Java JRUN server routine, respectively. The hard disk drive further stores a game server routine 123. Generally, these routines co-operate to direct the processor circuit 52 to execute game server functionality, as described in greater detail below. Additionally in the present embodiment, among other functions, these routines configure the processor circuit to invoke a Stored Procedure function of the database 100 to define and maintain various linked tables therein, which in this embodiment include a user table 102, a user game table 104, a games table 106, a game configuration table 108, a hand summary table 110, a hand details table 112, and a house values table 114, described in greater detail below.

In this embodiment the web server routine 120, Java application server routine 122 and game server routine 123 further direct the processor circuit 52 to invoke the Stored Procedure function of the database 100 to define and maintain various log records, which in this embodiment include a transaction log 130, a connection log 132, and a session log 134, as described in greater detail below.

In this embodiment, unless stated otherwise, each update of any tables or logs in the database 100 is performed by calling the Stored Procedure function of the database, although specific reference to this function will be omitted for ease of illustration.

Similarly, in the present embodiment the hard disk drive 86 also stores object codes 124 for directing the processor circuit to define various objects in the RAM 88. More particularly, in this embodiment the various routines described herein and the Java Virtual Machine 94 co-operate to direct the processor circuit 52 to define a plurality of Java objects, including a user session object 140 corresponding to each user logged onto the game server 54, a game object 150 corresponding to each game available on the game server, and a waiter object 170 corresponding to each user presently waiting to play a game on the game server. For ease of illustration, only a single example of each such object is shown in FIG. 3, however, in practice it is expected that there will be a plurality of each such type of object.

In this embodiment the user session object 140 includes a pointer to a corresponding player session object 142, which in turn includes a hand object 144. The user session object 140, the player session object 142 and the hand object 144 include respective sets of instruction codes, or more particularly, a user session object options routine 141, a player session object options routine 143 and hand object instruction codes 145. Also in this embodiment, the game object 150 includes various instruction codes, including a game routine 156, for example. These objects are discussed in greater detail below.

In the present embodiment the various routines described herein further direct the processor circuit 52 to define various additional registers or storage areas in the RAM 88, including a global values table 160, a winners register 162 and a waiters list 164. The global values table 160 is used for storing various incremented currently-unassigned values, for use by the processor circuit in generating new records in the various tables of the database 100. In this regard, in the present embodiment, the global values table maintains respective fields for various unique identification numbers, which in this embodiment include a next hand number and a next financial transaction number, and when each such identification number is required for creation of a record described herein, the processor circuit retrieves the unique unassigned value currently stored in the corresponding field of the global values table, and increments the contents of that field for the next time a unique value of that type will be needed. The winners register 162 is used to temporarily store an identification of one or more winners of a hand of a game, and in this embodiment includes a separate field for use in connection with each of the games in progress on the game server 54. The waiters list 164 is used to store pointers to memory locations in the RAM 88 of one or more waiter objects 170, each such object corresponding to a player who is waiting to play a game on the game server 54.

In the present embodiment, the hard disk drive 86 further stores a financial transaction routine 126, for providing conventional external financial transaction capability, such as transfers of money from (or to) users' external credit card or bank accounts to (or from) the users' internal accounts on the game server 54, for example. More particularly, in this embodiment the financial transaction routine 126 includes a financial transaction processing routine available from SureFire Commerce Inc. of Montreal, Canada (http://www.sfcommerce.com). Alternatively, however, any other suitable financial transaction routine may be substituted.

Also in this embodiment, the hard disk drive 86 stores a lobby applet 127 and a game applet 128, to be uploaded to the clients 66 shown in FIG. 2 to facilitate communication between such clients and the game server 54.

In this embodiment, the hard disk drive 86 also stores a wait watcher routine 129, for directing the processor circuit 52 to maintain waiting lists for the various games available on the game server, and to offer waiting players an opportunity to be seated when a free seat becomes available, as discussed in greater detail below.

Generally, in this embodiment, unless indicated otherwise, each server-initiated communication from the game server 54 to any of the clients 66 over the network 64 is conducted via an “unsecure pipe”, or in other words, is an unencrypted transmission. Conversely, in this embodiment, unless indicated otherwise, each client-initiated communication from a client to the game server is conducted via a “secure pipe”, or in other words, is encrypted. Similarly, each client-initiated communication from the game server back to the client (for example, where the game server is responding to a client-initiated request, such as by transmitting dealt cards to the user in response to a request for such cards) is also conducted via the secure pipe.

In this embodiment, each client-initiated communication received from a client by the game server 54 via the secure (encrypted) channel is processed by the processor circuit 52 under the direction of various routines, in a hierarchical manner. In this regard, the web server routine 120 directs the processor circuit 52 to respond to the communication if it is a hypertext markup language (.html) related request, and to pass other communications to the Java application server routine 122. Similarly the Java application server routine directs the processor circuit 52 to respond to various Java Server Page (.jsp) communications, and to pass further communications to the game server routine 123 for response. In turn, the game server routine directs the processor circuit to respond to various communications directly, and to pass further commands to the logic of the user session object 140. Finally, the user session object logic directs the processor circuit to respond to certain communications, and to pass others to the logic of the player session object 142 for response. This hierarchical treatment of communications is illustrated below, in the context of these various routines.

Database Tables

User Table

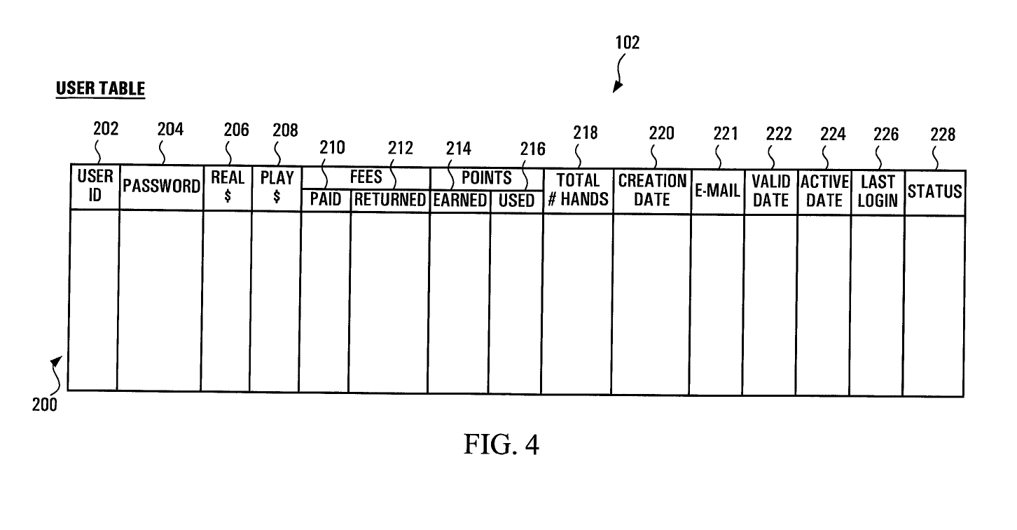

Referring to FIGS. 2, 3 and 4, the user table of the present embodiment is shown generally at 102 in FIG. 4. In this embodiment the user table 102 includes a plurality of user records shown generally at 200, with one such record corresponding to each user (such as the player 60 for example) of the apparatus 50. Generally, each such user record stores information specific to a particular corresponding user of the game server 54.

More particularly, in this embodiment each of the user records in the user table 102 includes a user ID field 202, a password field 204, a real money field 206, a play money field 208, a fees paid field 210, a fees returned field 212, a points earned field 214, a points used field 216, a total number of hands field 218, a creation date field 220, an e-mail field 221, a valid date field 222, an active date field 224, a last login field 226 and a status field 228.

In the present embodiment the user ID field 202 is used to store a unique identification of the particular user or player to whom the particular user record 200 corresponds, and the password field 204 is used to store a password that the user may enter to gain access to the game server 54. The real money field 206 is used to store a total amount of real money available to the user for use in playing games on the game server 54. In this regard, the user may transfer money into the real money field 206 by invoking conventional on-line payment methods (not part of this invention), such as on-line credit card payment or on-line bank account debiting, for example. Preferably, the game server 54 does not store the user's credit card information, to reduce security risks to the user, but rather, uses a third party secure financial transaction provider for this purpose. Similarly, the play money field 208 is used to store an amount of play money available to the user. In this regard, a proprietor of the game server 54 may choose to operate a number of games with “play” money, and may choose to provide a limited amount of such play money to a user, so that the user can try out a given game before beginning to play a game with real money.

In this embodiment, the fees paid field 210 is used to store a cumulative amount of transaction fees paid by the user to whom the particular user record 200 corresponds, and conversely, the fees returned field 212 is used to store a cumulative amount of transaction fees refunded to the user. In this regard, it is contemplated that where an on-line payment transaction method is used to deposit funds into the real money field 206 of the user record 200, the proprietor of the game server 54 may choose to charge the user for any transaction fees associated with the payment. For example, if the user uses a credit card from a company that charges a 3% transaction fee, to deposit $100.00 into the user's real money field 206, the processor circuit 52 may be configured to deposit $97.00 into the user's real money field, and to deposit the remaining $3.00 into an account of the proprietor (not shown), to cover the $3 transaction fee that the proprietor will have to pay to the credit card company. If so, then the processor circuit may also be configured to increment the contents of the fees paid field 210 of the user record 200, to keep a running total of all transaction fees paid by the user. The processor circuit may be further configured to refund a portion of such transaction fees to the user, upon the occurrence of a pre-defined event, such as the user having played a threshold number of hands, or having paid a threshold amount of transaction fees, for example, in which case the processor circuit may be configured to transfer the refunded portion of the transaction fees from the proprietor account (not shown) back to the real money field 206 of the user record 200, and to increment the contents of the fees returned field 212 by the refunded amount. Similarly, the points earned field 214 may be used to store a total number of loyalty points earned by the user to whom the user record 200 pertains, in response to pre-defined events, such as the playing of a predefined number of hands, for example, and likewise the points used field 216 may be used to store a total number of such loyalty points redeemed by the user for loyalty rewards, such as money or merchandise, for example. Alternatively, however, the fees and points fields 210 through 216 may be omitted if desired. As these fields are not central to the functioning of the present embodiment, they will not be described in greater detail herein.

In the present embodiment, the total number of hands field 218 stores a number representing the total number of hands that have been played by the user to whom the particular user record 200 pertains. The creation date field 220 stores a datestamp representing the date that the user record 200 was created. The e-mail field 221 stores an e-mail address of the user, and the valid date field 222 stores a date representing a date from which the user record 200 is considered to be valid, to authorize use of the game server 54 by the user to whom the user record pertains. In this regard, once a user has interacted with the game server to create the user record 200, the processor circuit may be configured to forward a verification message to the e-mail address stored in the e-mail field 221, the verification message including a hyperlink to be actuated by the user to validate the user record 200. Upon receiving signals over the network 64 representing actuation of such a hyperlink, the processor circuit may be directed to store a datestamp in the valid date field 222 to indicate that the user record 200 is valid from that date forward. The active date field 224 is used to store a datestamp indicating the earliest date on which the user first transferred money into the real money field 206 of the user record 200. The last login field 226 is used to store the time and date of the last login by the user, and the status field 228 may be used to store optional status information regarding the user, such as indications of any restrictions or prohibitions applicable to the particular user's use of the game server 54.

User Game Table

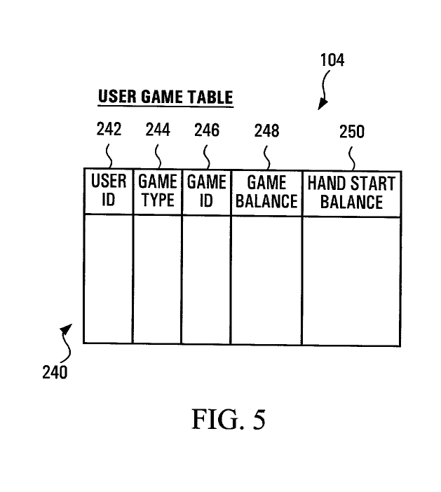

Referring to FIGS. 2, 3, 4 and 5, the user game table is shown generally at 104 in FIG. 5. Generally, the user game table 104 is used to store a plurality of user game records, shown generally at 240, each such user game record corresponding to a particular game played by a particular user.

More particularly, in this embodiment each user game record 240 includes a user ID field 242, a game type field 244, a game ID field 246, a game balance field 248, and a hand start balance field 250. The user ID field 242 stores a unique identification of the particular user or player. Referring to FIGS. 4 and 5, for a particular user, the user ID field 242 contents are identical to the contents of the user ID field 202 of the user table 102, or in other words, the user ID fields 202 and 242 are linked.

In the present embodiment the game type field 244 is used to store a two-character identification of a type of game, such as “GU” denoting guts poker or “SS” denoting seven card stud, for example. The game ID field 246 is used to store a unique number uniquely identifying a particular “table” or “room” at which the game is being played. In this regard, in the present embodiment a user of the game server 54 can select from a wide plurality of different tables, at which a variety of different games are being played.

In this embodiment the game balance field 248 is used to store a value representing a net amount of either real money or play money (depending on the particular game being played, as determined by the contents of the games table 106, discussed below) that the user presently has at this particular “table” or “room”. In this regard, a user may choose to initially bring only a portion of his or her total money (stored in either the real money field 206 or the play money field 208 of the user record 200 shown in FIG. 4 corresponding to the user) into a particular room or table. Similarly, the hand start balance field 250 stores a value representing the amount of money that the user had at the table at the beginning of the present hand. In this embodiment, for each user game record, the contents of the hand start balance field 250 are set equal to the contents of the game balance field 248 at the commencement of the hand, so that, in the event of a server failure occurring in mid-hand for example, the contents of the hand start balance field may be used to effectively refund all players' antes or bets that were contributed during the failed hand.

Games Table

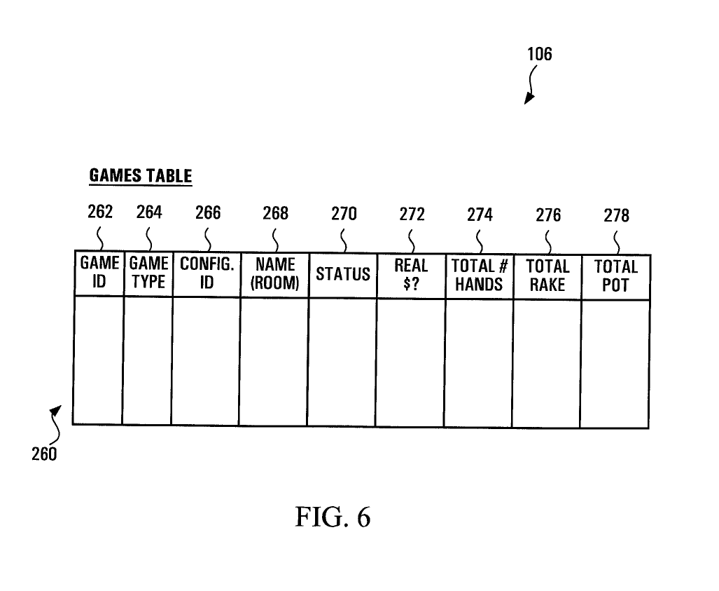

Referring to FIGS. 2, 3, 5 and 6, the games table is shown generally at 106 in FIG. 6. In this embodiment the games table 106 stores a plurality of game records 260, each of which stores parameters defining the game being played at a particular “table” or “room”.

More particularly, in this embodiment each of the game records 260 includes a game ID field 262, a game type field 264, a configuration ID field 266, a name field 268, a status flag field 270, a real money flag field 272, a total number of hands field 274, a total rake field 276, and a total pot field 278.

In this embodiment, the game ID field 262 is used to store the unique number uniquely identifying the particular “table” or “room” at which the game is being played, and the game type field 264 is used to store a two-character identification of a type of game, such as “GU” denoting guts poker. In this regard, it will be appreciated that for a particular game, the contents of the game ID field 262 and the game type field 264 of the game record 260 are identical to the contents of the game ID fields 246 and the game type fields 244 respectively of all user game records 240 in the user game table 104 corresponding to all users currently playing that particular game. In other words, the game type fields 244 and 264 are linked, as are the game ID fields 262 and 246.

In the present embodiment the configuration ID field 266 is used to store a unique number identifying a particular game configuration applicable to the particular game to which the game record 260 corresponds. This unique number is used to link the game record 260 to a particular game configuration record in the game configuration table 108, discussed in greater detail below. The name field 268 is used to store a name of the table or room in which the particular game is being played, such as the “Hawaiian Room”, for example.

In this embodiment, the status flag field 270 is used to store a status flag indicating whether or not any players are presently playing the particular game to which the game record 260 corresponds. The real money flag field 272 is used to store a flag indicating whether or not real money (as opposed to play money) is being used for the particular game.

The total number of hands field 274 in this embodiment stores a number representing the cumulative total number of hands of that particular game (or in other words, hands at that table) that have been played. The total rake field 276 stores a value representing the total cumulative “rake” (or in other words, the total house's share collected by the proprietor of the game server 54, such as 5% of each pot for example) that has been collected from that particular game or table. Similarly, the total pot field 278 stores a value representing the total cumulative “pot”, or in other words the total cumulative winnings (gross, before subtraction of the “rake”) that have been won by players of the particular game. For a given game record 260, the contents of the total pot field 278 may be divided by the contents of the total number of hands field 274 to produce an average pot value, which may be of interest to prospective players in deciding whether or not to play the particular game.

Game Configuration Table

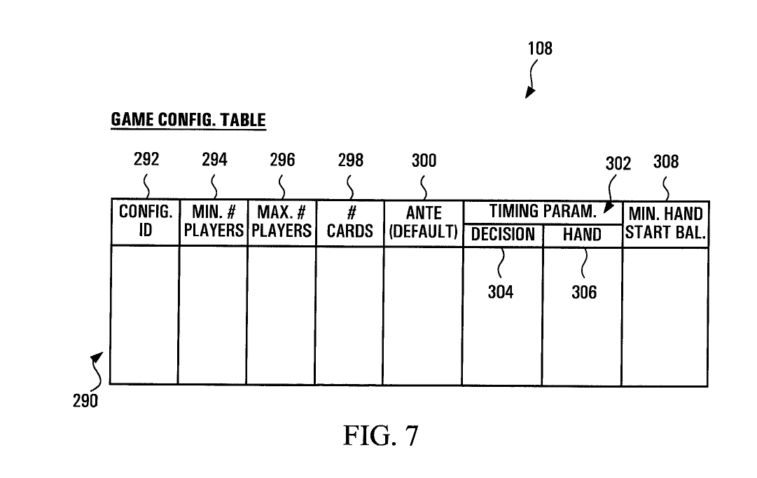

Referring to FIGS. 2, 3, 5, 6 and 7, the game configuration table is shown generally at 108 in FIG. 7. In this embodiment the game configuration table 108 stores a plurality of configuration records 290, each of which specifies a particular game configuration. The game configuration defined by a given configuration record may be imposed on any particular game available on the game server 54, by storing a link to the relevant configuration record 290 in the configuration ID field 266 of the game record 260 of the games table 106 corresponding to that particular game.

In this embodiment, each configuration record 290 includes a configuration ID field 292, a minimum number of players field 294, a maximum number of players 296, a number of cards field 298, a default ante field 300, timing parameters fields 302 including a decision time field 304 and a hand delay time field 306, and a minimum hand start balance field 308.

The configuration ID field 292 in the present embodiment stores a unique number identifying the particular game configuration to which the configuration record 290 corresponds. Referring to FIGS. 6 and 7, for a particular configuration, the configuration ID field 292 contents are identical to the contents of the configuration ID field 266 of the games table 106, or in other words, the configuration ID fields 292 and 266 are linked.

In this embodiment, the minimum number of players field 294 stores a minimum number of players that are required in order to play a game defined by the configuration record 290, and similarly, the maximum number of players field 296 stores a maximum permitted number of players. The number of cards field stores a number, such as 2, 3, 5 or 7 for example, specifying the number of cards that are to be dealt to each player.

In the present embodiment, the default ante field 300 stores a default ante amount. More particularly, in this embodiment the default ante amount is to be paid by all players for the first hand of a round of the game, and for each subsequent hand of the round, the default ante amount is to be paid by those who either won or folded in the previous hand of the round.

The timing parameters fields 302 in the present embodiment store timing values used by the processor circuit 52 to define various time intervals. More particularly, in this embodiment the decision time field 304 is used to store a value representing a maximum permitted decision time for a player to enter a given decision, such as an “ante/sit out” decision to commence a hand, or an “in/fold” decision during the hand, for example. If the player fails to enter such a decision within the time limit specified by the decision time field 304 for the particular game configuration, the processor circuit is configured to impose a default decision, which in this embodiment will generally be the decision choice that does not require further payment by the player, such as “sit out” at the commencement of a hand or “fold” during the hand, for example. The hand delay field 306 stores a value representing a time delay between successive hands of a round, to allow the players to pause to observe the outcome of a given hand before the next hand commences.

In this embodiment the minimum hand start balance field 308 stores a value representing a minimum hand start balance that any player or user must have, as defined by the contents of the hand start balance field 250 of the user game record 240 shown in FIG. 5 corresponding to a particular user and game, in order to commence playing any hand of the game.

Hand Summary Table

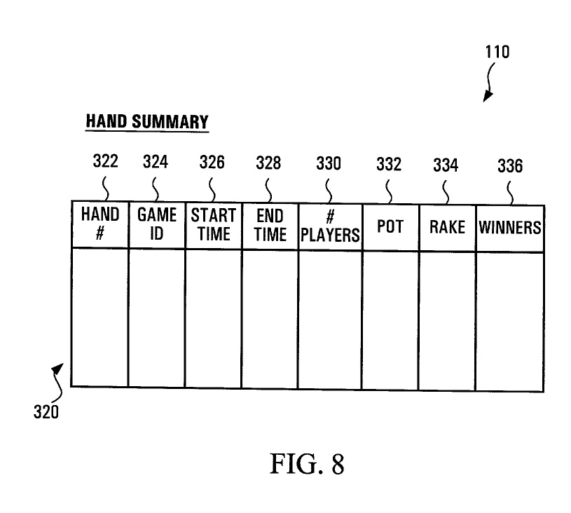

Referring to FIGS. 2, 3, 4, 5, 6 and 8, the hand summary table is shown generally at 110 in FIG. 8. In this embodiment, the hand summary table 110 includes a plurality of hand summary records 320, each of which is used to store summary information regarding a particular hand that has been played.

In this embodiment, each hand summary record 320 includes a hand number field 322, a game ID field 324, a start time field 326, an end time field 328, a number of players field 330, a pot field 332, a rake field 334 and a winners field 336. The hand number field 322 is used to store a unique number, uniquely identifying the particular hand to which the hand summary record 320 corresponds. The game ID field 324 is used to store the unique number uniquely identifying the particular “table” or “room” at which the hand was played, and thus this field is linked to the game ID fields 246 and 262 shown in FIGS. 5 and 6 respectively.

In this embodiment the start and end time fields 326 and 328 are used to store the start time and date and the end time and date, respectively, of the hand to which the particular hand summary record 320 relates. The number of players field 330 stores the number of players who played the hand. The pot field 332 stores a value representing the dollar amount of the pot of the hand, and the rake field 334 stores a value representing the dollar amount of the “rake”, or in other words the share of the pot taken by the “house”, or the proprietor of the game server 54, as a fee for providing the game server. The winners field 336 stores the unique user ID number of the winner of the hand, and in the event of a tie or a hand with more than one winner, the winners field 336 stores the user ID numbers of all such winners of the hand. In this regard, for a particular winner, the user ID number stored in the winners field 336 is identical to the user ID stored in the user ID fields 202 and 242 of the user table 102 and the user game table 104 shown in FIGS. 4 and 5, respectively. Effectively, therefore, the winners field 336 is linked to the user ID fields 202 and 242.

Hand Details Table

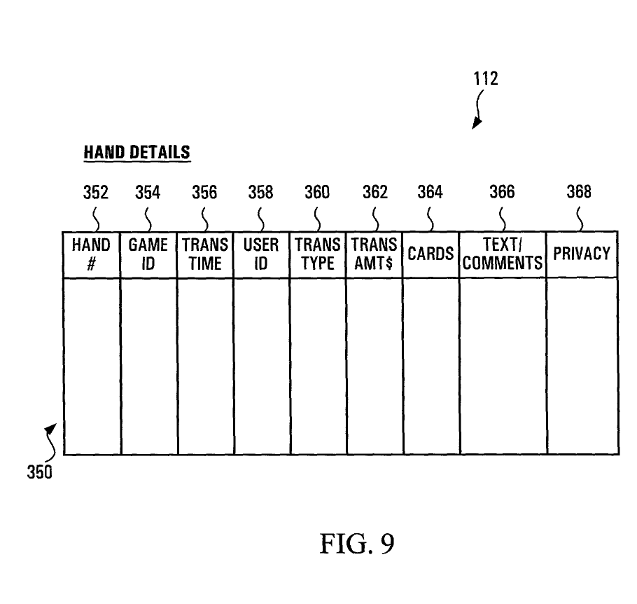

Referring to FIGS. 3, 4, 8 and 9, the hand details table is shown generally at 112 in FIG. 9. Generally, the hand details table 112 stores more detailed information relating to a hand that has been played than the hand summary table 110 shown in FIG. 8. More particularly, in this embodiment the hand details table 112 stores a plurality of hand details records 350, each record relating to a particular transaction that occurred during the hand. Thus, for any given hand, there is one hand summary record 320, but there are a plurality of hand details records 350.

More particularly still, in this embodiment each hand details record 350 includes a hand number field 352, a game ID field 354, a transaction time field 356, a user ID field 358, a transaction type field 360, a transaction amount field 362, a cards field 364, a text field 366, and a privacy flag field 368. The hand number and game ID fields 352 and 354 serve to identify the particular hand and table to which the record relates, and for any given hand, the contents of these fields are identical to those of the hand number and game ID fields 322 and 324 of a hand summary record 320 in the hand summary table 110 shown in FIG. 8 corresponding to the same hand.

In this embodiment the transaction time field 356 stores a value representing the time of occurrence of the particular transaction to which the hand details record 350 relates. The user ID field 358 stores the unique user ID of a user associated with the particular transaction, and for a given user, the contents of this field are identical to the contents of the user ID field 202 of the user table 102 shown in FIG. 4.

In the present embodiment, the transaction type field 360 stores a value representing a particular type of transaction. More particularly, in this embodiment the transaction type field 360 stores a numerical value representing the type of transaction, and a separate transaction strings table (not shown) is used to store a textual description of each numerical transaction type. For example, in the present embodiment, possible transaction types include ante, automatic ante, sit out, deal, bet, raise, stay in, fold, win and lose.

The transaction amount field 362 in the present embodiment stores a value representing a dollar amount (if any) associated with the particular transaction to which the hand details record 350 relates. The cards field 364 is used to store identifications of particular cards associated with the transaction. In this regard, in the present embodiment the numbers 0-51 are used to represent a deck of cards, with 0-12 representing all clubs (A, 2, 3, . . . K), 13-25 representing all diamonds, 26-38 representing all hearts, and 39-51 representing all spades. For example, cards field 364 contents of “0, 20” represent the Ace of Clubs and the Eight of Diamonds.

The text field 366 is used to store textual comments, if any, associated with the transaction. In the present embodiment this field is not used but is maintained for possible use in other embodiments.

In this embodiment, the privacy flag field 368 is used to store a privacy flag, to indicate whether or not subsequent access to the contents of the hand details record 350 is to be restricted to the particular user, as identified by the contents of the user ID field 358, to whom the transaction described in the hand details record 350 relates.

House Values Table

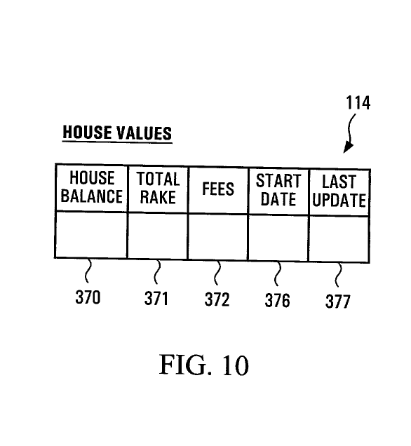

Referring to FIGS. 2, 3, 4, 6 and 10, the house values table is shown generally at 114 in FIG. 10. Generally, the house values table 114 serves to maintain a record of information relating to various cumulative aspects of the game server 54 as a whole, rather than specific games or hands thereon.

In this embodiment, the house values table 114 includes a house balance field 370, a total rake field 371, a fees field 372, a start date field 376, and a last update field 377.

In the present embodiment the house balance field 370 stores a house balance value representing the net amount of money presently held by the “house”, or in other words, by the game server 54. More particularly, in this embodiment the contents of the house balance field are equal to the sum of all money brought into the game server, minus the sum of all money taken out of the game server. More particularly still, to maintain this house balance value, each time a user transfers money from an external source into the real money field 206 of the user record 200 associated with the user, the contents of the house balance field 370 are incremented by the amount of money transferred, and conversely, each time a user logs off and transfers money back from the real money field 206 to an external source, the house balance field 370 contents are decremented by the amount transferred out.

Similarly, in this embodiment the total rake field 371 stores a total rake value representing the total “rake” earned, or in other words, the total amount of money that the proprietor of the game server 54 has taken from the pots of all hands played on the game server, effectively as a fee for operating the game server. In the present embodiment, the total rake value is effectively equal to a sum of the contents of the total rake fields 276 of the games records 260 of the games table 106 shown in FIG. 6, for all games available on the game server 54.

In the present embodiment, the fees field 372 stores a value representing the total amount of financial transaction fees, such as Visa or MasterCard transaction fees for example, that have been incurred by or on behalf of users of the game server 54. In the present embodiment, the start date field 376 stores a value representing a date at which the contents of the house values table 114 began to be incremented or used by the processor circuit 52, and the last update field 377 stores a timestamp value representing the time and date at which the contents of the house values table 114 were most recently updated.

Objects

User Session Object

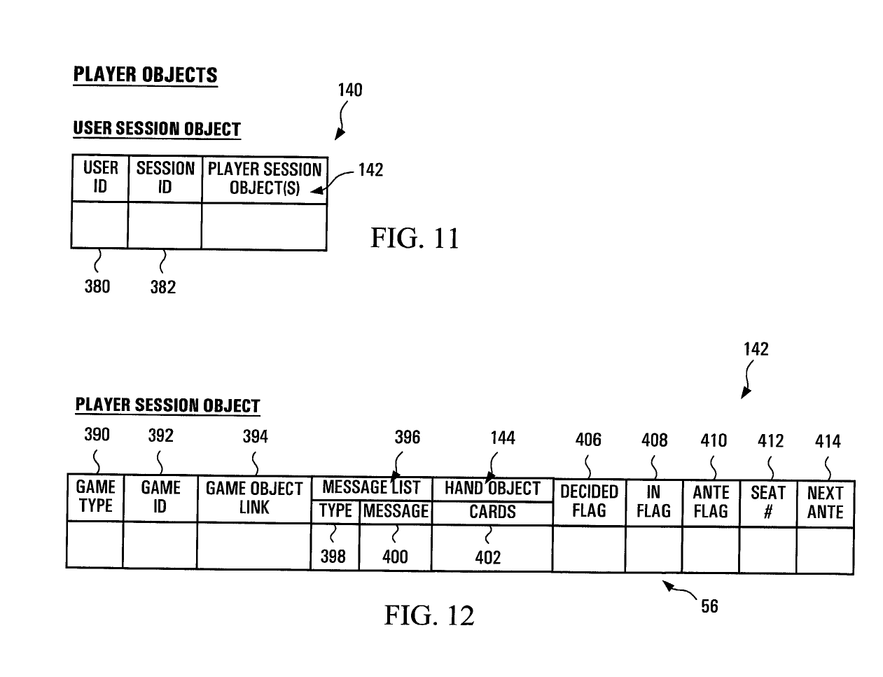

Referring to FIGS. 2, 3, 4 and 11, the user session object is shown generally at 140 in FIG. 11. In this embodiment the game server routine 123 shown in FIG. 3 configures the processor circuit 52 to define, in the RAM 88, a user session object 140 for each user that is presently logged onto the game server 54 shown in FIG. 2. Such a user session object is created for each user at the commencement of the session (i.e. at login), and is deleted from the RAM when the session ends (at logoff).

In this embodiment the user session object 140 is a Java object. More particularly, in this embodiment the user session object 140 includes a user ID field 380, a session ID field 382, and further includes the player session object 142.

The user ID field 380 is used to store the unique user ID of the particular user to whom the user session object 140 corresponds, as defined by the contents of the user ID field 202 of the user record 200 of the user table 102 shown in FIG. 4.

The session ID field 382 is used to store a unique number uniquely identifying the particular session (of the particular user) to which the user session object relates.

Player Session Object

Referring to FIGS. 2, 3, 5, 6, 9, 11 and 12, the player session object is shown generally at 142 in FIG. 12. As noted, when each user logs onto the game server 54 shown in FIG. 2, the game server routine 123 directs the processor circuit 52 to create a corresponding user session object 140, as discussed above and below. Similarly, when the user enters a “room” or “table” for a particular game, the user session object logic directs the processor circuit to create a corresponding player session object 142 within the user session object 140. In this embodiment, only one player session object 142 is permitted within each user session object 140, or in other words, the user may only be at one “table” at a time, whether that user is seated or merely watching. Alternatively, however, in other embodiments a user may be permitted to be at a plurality of tables simultaneously, in which case a plurality of player session objects may be permitted within each user session object.

In this embodiment, the player session object 142 includes a game type field 390, a game ID field 392, a game object link field 394, message list fields 396 including a message type field 398 and a message field 400. The player session object 142 further includes the hand object 144, which in turn includes a cards field 402. In addition, in the present embodiment the player session object includes a decided flag field 406, an “in” flag field 408, an ante flag field 410, a seat number field 412, and a next ante field 414.

The game type field 390 is used to store the two-character identification of the type of game that is being played in the room that the user has entered, such as “GU” denoting guts poker or “SS” denoting seven card stud, for example. For a given game type, the contents of the game type field 390 are identical to those of the game type fields 244 and 264 of the user game table 104 and the games table 106 shown in FIGS. 5 and 6. Similarly, the game ID field 392 stores the unique number uniquely identifying the particular “table” or “room” that the user has entered, and for a given table or room, the game ID field 392 contents are identical to those of the game ID fields 246, 262, 324 and 354 of the user game table, the games table, the hand summary table and the hand details table described above.

In this embodiment, the game object link field 394 stores a link or pointer to a memory location in the RAM 88 shown in FIG. 3 where the game object 150 for the room the user has entered is stored.

The message list fields 396 are used to store various types of messages, such as “chat” messages between players at the table or room, or messages from a system administrator of the game server 54 to the players, for example. The message type field 398 stores an indication of the type of message, and the message field 400 stores the text of the message itself.

The hand object 144 stores information representing a hand presently held by the user to whom the player session object 142 relates. In this regard, the cards field 402 stores numeric representations of the cards presently held by the player, as described above in connection with the cards field 364 of the hand details table 112 shown in FIG. 9. The hand object 144 further includes logic (not shown) that directs the processor circuit 52 to generate a hand value representing the best possible poker hand that can be formed using the cards identified by the contents of the cards field 402. For example, if the contents of the cards field 402 are “12, 25”, representing a King of Clubs and a King of Diamonds, then the logic of the hand object 144 directs the processor circuit to generate a value representing a “pair of kings”. Alternatively, if the cards field contents are “12, 23” representing a King of Clubs and a Jack of Diamonds, a value representing a “king high” is generated. In this embodiment, wherein two-card hands are played, only pairs or high-card hands are possible, and hand values exist to identify each such hand. Alternatively, however, in a three-card Guts poker embodiment, in addition to high-card hands or pairs, straights, flushes, three of a kind, and straight flushes are possible, and corresponding hand values may be employed to identify such hands. Similarly, five-card embodiments, or other numbers of cards, may be substituted if desired. Such embodiments having five or more cards may use standard poker logic for determining hierarchies of poker hands, for example.

In the present embodiment, the decided flag field 406 is used to store a decision flag indicative of whether or not a user has made a decision. In this regard, whenever a user is prompted to make a decision, such as “ante/sit out” or “in/fold” for example, the game object game routine directs the processor circuit to set the decision flag inactive, and to await user input providing the decision, in response to which the processor circuit sets the decision flag active.

In this embodiment, the in flag field 408 is used to store an “in” flag, indicative of whether or not the user has decided to remain “in” rather than fold. Similarly, the ante flag field 410 is used to store an ante flag, indicative of whether or not the user has anted for the present hand and is entitled to be dealt cards.

The seat number field 412 is used to store a number representing a seat number at the table at which the user to whom the player session object corresponds is seated.

The next ante field 414 in the present embodiment is used to store a value that may be either a dollar value or a flag, as discussed in greater detail below in connection with the game object game routine.

Game Object

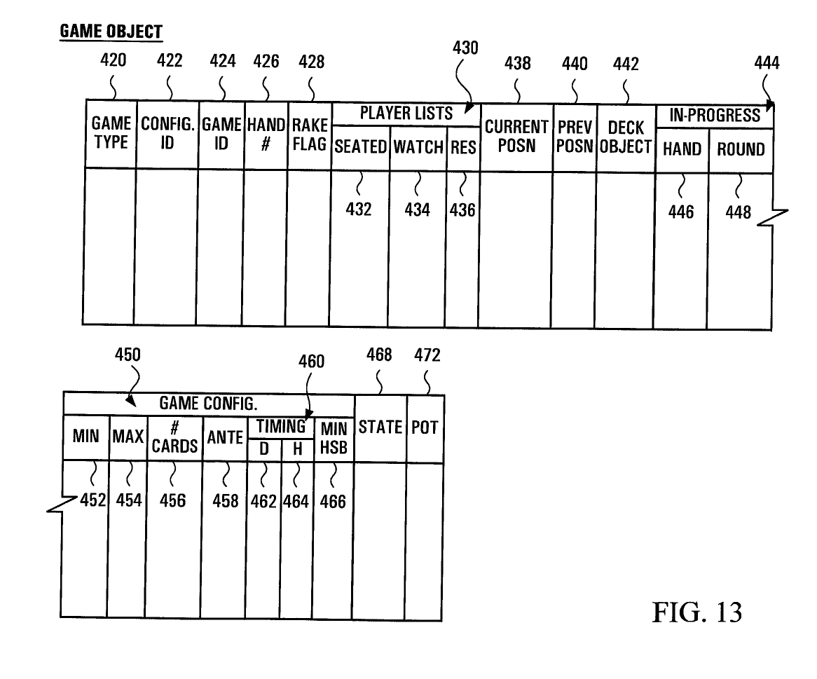

Referring to FIGS. 2, 3, 6, 7 and 13, the game object is shown generally at 150 in FIG. 13. In this embodiment, for each “game” occurring at a corresponding respective table or room, the Java application server routine 122 and the game server routine 123 co-operate to direct the processor circuit to define a corresponding game object 150 in the RAM 88.

In this embodiment, each game object 150 includes a game type field 420, a configuration ID field 422, a game ID field 424, a hand number field 426, a rake flag field 428, and player lists 430, including a seated field 432, a watching field 434 and a reserved field 436. Each game object further includes a current position field 438, a previous position field 440, and a deck object 442. In addition, in the present embodiment each deck object includes an in-progress field 444 which in turn includes a hand-in-progress flag field 446 and a round-in-progress flag field 448. Each game object 150 in the present embodiment further includes a game configuration field 450, a state field 468, and a pot field 472.

The game type, configuration ID and game ID fields 420, 422 and 424 include information obtained from the corresponding similarly-named fields 264, 266 and 262 of the games record 260 in the games table 106 shown in FIG. 6 corresponding to the game defined by the game object 150. The hand number field 426 stores the unique number uniquely identifying the current hand in progress, of the game in question.

In this embodiment, the rake flag field 428 stores a flag indicative of whether or not real money (as opposed to play money) is being used at the game to which the game object 150 corresponds. If the flag is set inactive to indicate play money, then it is not necessary for the proprietor of the game server 54 to take any “rake” from the pot at that table.

In the present embodiment, the player lists 430, or more particularly the seated, watching and reserved fields 432, 434 and 436, effectively include lists of all players who are seated at the table (i.e., playing the game), players who are watching the game, and players who were waiting for a free seat to play the game and have been presented with a time-limited opportunity to sit down, during which time a seat is “reserved” for them, respectively. More particularly, in this embodiment, the seated field 432 includes a link or pointer to a location in the RAM 88 of each player session object 142 for each respective player who is presently “seated” at the game defined by the game object 150. Similarly, the watching field 434 includes links to memory locations of player session objects 142 for players who are presently “watching” the game, and the reserved field 436 includes one or more unique user IDs of players for whom a seat at the game defined by the game object 150 has been temporarily “reserved” by the processor circuit 52 under the direction of the wait watcher routine 129, as discussed below.

In this embodiment, the current position field 438 stores a value representing a seat number at the table of a player whose turn it is to make a decision, for use in any situation (such as betting for example) where player decisions must be made sequentially rather than simultaneously. Similarly, the previous position field 440 stores a value representing a seat number at the table of the player who made the most recent decision.

In the present embodiment, the deck object 442 includes 52 sub-fields, for storing respective card numbers between 0 and 51 representing respective corresponding cards of a deck. The deck object 442 further includes logic comprising codes for directing the processor circuit 52 to shuffle the deck of cards. More particularly, to achieve such shuffling in the present embodiment, the deck object logic codes direct the processor circuit to execute a pseudo-random number generation algorithm, using a time value obtained from a system clock (not shown) of the game server 54 to “seed” the pseudo-random number generation process. The processor circuit is directed to select two random sub-field location numbers between 0 and 51 in this manner, and to switch the card numbers stored in such sub-field locations with each other, effectively switching the positions of two cards in the deck. The deck object logic codes direct the processor circuit 52 to repeat this card-switching step one million times, to effectively shuffle the deck of cards represented by the contents of the 52 sub-fields of the deck object 442.

In this embodiment, the hand-in-progress flag field 446 stores a bit that is set active to indicate that a hand of a round of the game represented by the game object 150 is in progress. Similarly, the round-in-progress flag field 448 stores a bit that is set active to indicate that a round of the game is in progress, as discussed in greater detail below.

The game configuration field 450 includes information obtained from the corresponding game configuration record 290 in the game configuration table 108 shown in FIG. 7 having the same configuration ID field 292 contents as the configuration ID field 422. Accordingly, the game configuration field 450 includes a minimum number of players field 452, a maximum number of players field 454, a number of cards field 456, a default ante field 458, timing parameters 460 including a decision time field 462 and a hand delay field 464, and a minimum hand start balance field 466, corresponding to the similarly-named fields 294 through 308 of the game configuration record 290. Each of these fields contain information corresponding to their similarly-named counterpart fields in the game configuration record 290 corresponding to the game to which the game object 150 relates.

The state field 468 stores an integer representing a state value, for use by the processor circuit 52 in identifying a current state of the game. For example, one state value may indicate that the processor circuit is presently awaiting “in/fold” decisions from the players.

Finally, in this embodiment the pot field 472 is used to store a value representing the current “pot” of a hand presently in progress.

Waiter Object

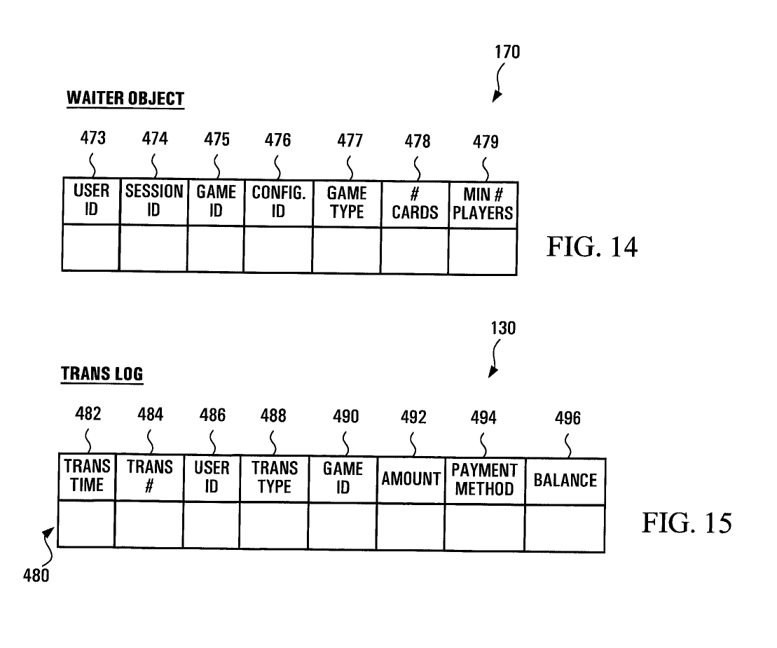

Referring to FIGS. 2, 3 and 14, an exemplary waiter object is shown generally at 170 in FIG. 14. As noted, such a waiter object 170 is generated and maintained in the RAM 88 for each player who is waiting to play a game on the game server 54.

In this embodiment the waiter object 170 includes a user ID field 473, a session ID field 474, a game ID field 475, a configuration ID field 476, a game type field 477, a number of cards field 478, and a minimum number of players field 479. The user ID field 473 is used to store the unique user ID of the particular user who is waiting to play a game, and the session ID field 474 is used to store the session ID corresponding to the user's current log-in session (see discussion above of corresponding user ID field 202 and session ID field 382, for example). In this embodiment, if the user is waiting to play at a particular game, then the game ID field 475 is used to store the unique game ID (discussed above in connection with the game ID field 246) of that particular game.

Otherwise, if the user is waiting to play any similarly-configured game, the game ID field 475 stores a value of −1, indicating that the user may be seated at any one of a plurality of games matching the criteria specified in the remainder of the waiter object 170. For this latter purpose, the configuration ID field 476, the game type field 477, the number of cards field 478 and the minimum number of players field 479 store further information generally defining a game configuration that is acceptable to the user (see discussions elsewhere herein of the corresponding configuration ID field 292, game type field 264, number of cards field 298 and minimum number of players field 294 shown in FIGS. 6 and 7, for example). In this embodiment, although the first three of these fields are dictated by the contents of the games table and game configuration table records, the minimum number of players field 479 may be used to specify a specific minimum number of players that must be seated at a given table before the particular user identified by the waiter object 170 wishes to sit at the table, which may be greater than or equal to the minimum number of players required to play a game at all, as specified by the minimum number of players field 294.

Logs

Transaction Log

Referring to FIGS. 2, 3, 4, 5 and 15, the transaction log is shown generally at 130 in FIG. 15. In this embodiment, the transaction log 130 is used to store a plurality of transaction log records 480, to maintain records of financial transactions conducted in connection with the game server 54.

In the present embodiment, each transaction log record 480 includes a transaction time field 482, a transaction number field 484, a user ID field 486, a transaction type field 488, a game ID field 490, an amount field 492, a payment method field 494 and a balance field 496.

In this embodiment, the transaction time field 482 stores the time and date of occurrence of the transaction to which the transaction log record 480 relates. The transaction number field 484 stores an optional unique number, uniquely identifying the transaction. The user ID field 486 stores the unique user ID of a user associated with the transaction (i.e., the same user ID as stored in the user ID field 202 of the user record 200 corresponding to that user, as stored in the user table 102 shown in FIG. 4).

The transaction type field 488 in the present embodiment stores an indication of the type of transaction recorded in the transaction log record 480. For example, in this embodiment the transaction type may store a value representing one of the following: an external deposit, an external withdrawal, an internal credit, an internal debit, fees paid, or fees returned. An external deposit indicates a deposit, from an external source, to a user's account on the game server 54, such as a transfer of funds from a user's bank account or credit card to the real money field 206 of the user record 200 shown in FIG. 4 corresponding to the user, for example. An external withdrawal indicates a withdrawal from an account of the user on the game server, to an external source, such as a transfer of the user's funds out of the user's real money field 206 and into the user's external bank account or credit card account, for example. An internal credit indicates a transfer of funds to a user's main account on the game server, from a user's secondary account on the game server. For example, when a user “leaves” a room or table, an internal credit is performed, by which funds from the game balance field 248 of the user game record 240 corresponding to the user, are transferred to the real money field 206 of the user record 200 corresponding to the user. Conversely, an internal debit indicates a transfer from the user's main account to the user's secondary account, such as a transfer of funds from the user's real money field 206 to the user's game balance field 248 when the user “enters” a room or table, for example. Fees paid indicates a debit of the user's main account (real money field 206) for transaction fees owed to an external source, such as a 3% transaction fee owed to a credit card company in respect of an external deposit from the user's credit card, for example. Conversely, fees returned indicates a voluntary partial or complete refund of such fees to the user's main account from the proprietor of the game server 54, as a loyalty reward for the user, as discussed above in connection with the fees paid and fees returned fields 210 and 212 of the user table 102.

In this embodiment, the game ID field 490 stores the unique game ID of a room or table (if any) associated with the transaction to which the transaction log record 480 relates. In this regard, it will be appreciated that in the present embodiment, internal credits and internal debits, as discussed above in connection with the transaction type field 488, will have such an associated room or table, whereas external deposits, withdrawals, fees paid and fees returned will generally not.

The amount field 492 stores a value representing the amount of the transaction.

The payment method field 494 in the present embodiment stores an indication of a payment method. For example, in the case of an external deposit transaction, the contents of the payment method field 494 may indicate a Visa transaction, a MasterCard transaction, or a debit card transaction, for example. In the case of an internal credit, the payment method field may indicate that the transaction occurred because the user left the table, or conversely, in the case of an internal debit, that the transaction occurred when the user opted to enter the room and bring money to the table.

In this embodiment, the balance field 496 stores a value representing a running balance of funds associated with the user identified by the contents of the user ID field 486. More particularly, in this embodiment, the balance field 496 contents represent the value of funds stored in the real money field 206 of the user record 200 corresponding to the user, immediately following the transaction to which the transaction log record 480 relates.

Connection Log

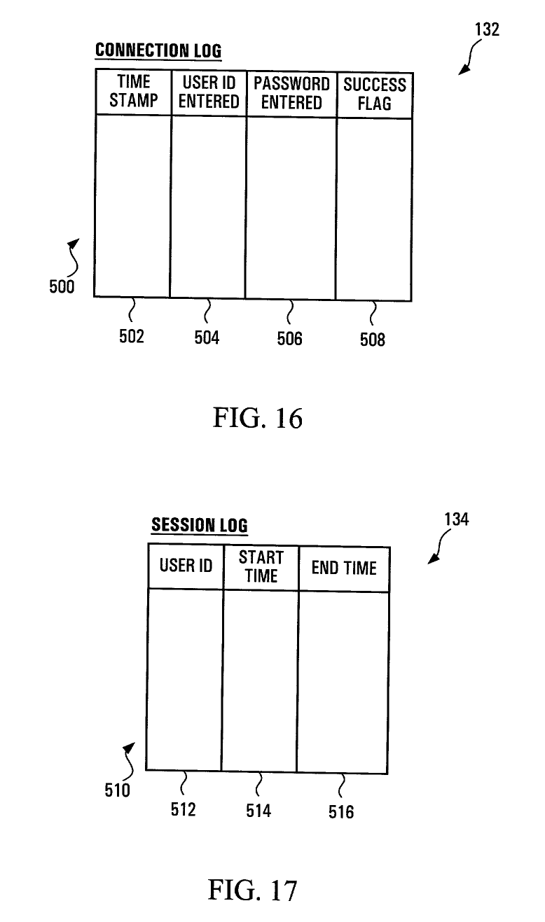

Referring to FIGS. 2, 3, 4 and 16, the connection log is shown generally at 132 in FIG. 16. The connection log stores a plurality of connection records 500, which together record every attempt to log onto the game server 54, by any person, regardless of whether such an attempt was successful.

In this embodiment, each connection record 500 includes a time stamp field 502, a user ID entered field 504, a password entered field 506, and a success flag field 508. The time stamp field 502 stores a time and date at which the logon attempt occurred. The user ID entered field and the password entered field store the user ID and the password entered by the user during the logon attempt. The success flag field 508 stores a bit which is set active if the logon attempt was successful (i.e., if the processor circuit 52 determined that the contents of the user ID entered and password entered field matched the contents of the user ID field 202 and password field 204 of a user record 200 in the user table 102), and which is otherwise left inactive.

Session Log

Referring to FIGS. 2, 3, 4 and 17, the session log is shown generally at 134 in FIG. 17. The session log maintains a plurality of session log records 510, each of which pertains to a particular session by a particular user following a successful login by that user.

In this embodiment, each session log record 510 includes a user ID field 512 for storing the unique user ID of the user, and further includes start time and end time fields 514 and 516 for storing time stamp information representing the time and date at which the user logged onto and logged off of the game server 54, respectively.

Operation

Web Server Routine

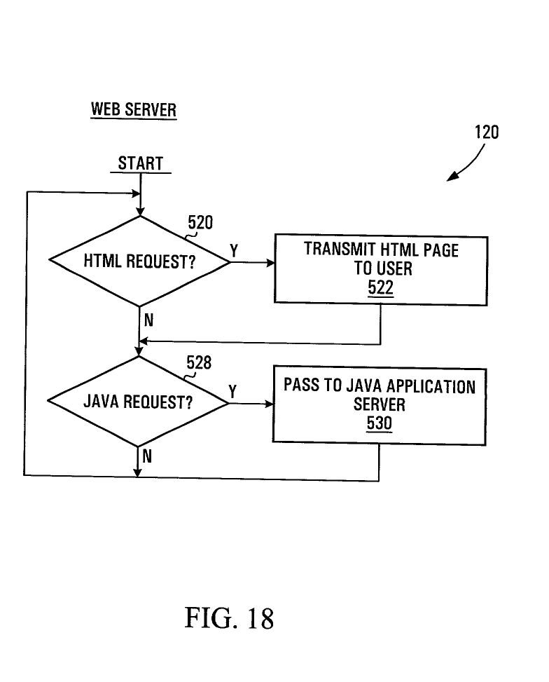

Referring to FIGS. 2, 3, 6 and 18, the web server routine is shown generally at 120 in FIG. 18. Generally, the web server routine 120 directs the processor circuit 52 to implement the various game server functions defined herein, both directly, by directing the processor circuit to perform certain functions, as well as indirectly, by passing various requests from clients 66 to the Java application server routine 122, to direct the processor circuit to respond accordingly.

In this embodiment the web server routine 120 begins with a first block of codes 520, which directs the processor circuit 52 to determine whether signals including a uniform resource locator (URL) identifying a hypertext markup language (.html) resource have been received via the network 64 from any of the clients 66 shown in FIG. 2, indicating a request to download an unrestricted-access .html resource such as a web-page identified by the URL, which in this embodiment is an unrestricted-access game server “home” page (not shown). If so, block 522 directs the processor circuit 52 to transmit signals representing the game server home page or other unrestricted-access .html resource to the requesting client. In this embodiment, the game server home page includes various options selectable by a user of the client, including a “new user” selection for new users to create accounts on the game server 54, as well as a “login” selection for existing users.

In this embodiment, following execution of blocks 520 and 522 if appropriate, block 528 directs the processor circuit 52 to determine whether signals including a Java code have been received via the network 64 from one of the clients 66, and if so, block 530 directs the processor circuit 52 to pass such signals to the Java application server routine 122, which in turn directs the processor circuit to respond to the signals appropriately. In this regard, it will be appreciated that in this embodiment, wherein the web server routine 120 and the Java application server routine 122 include a Microsoft Internet Information Server routine and a Java JRUN routine respectively, these server routines are pre-configured to co-operate with each other by passing such signals as required. For example, if block 528 of the web server routine detects signals received from a client including an identification of a .jsp Java Server Page, block 530 passes such signals to the Java application server routine 122, which responds by transmitting a representation of the requested .jsp page to the requesting client, and by executing any Java codes provided in the page, as appropriate.

The processor circuit 52 is then directed back to block 520, to continue awaiting receipt of .html or Java resource requests at blocks 520 and 528 as described above.

Java Application Server Routine

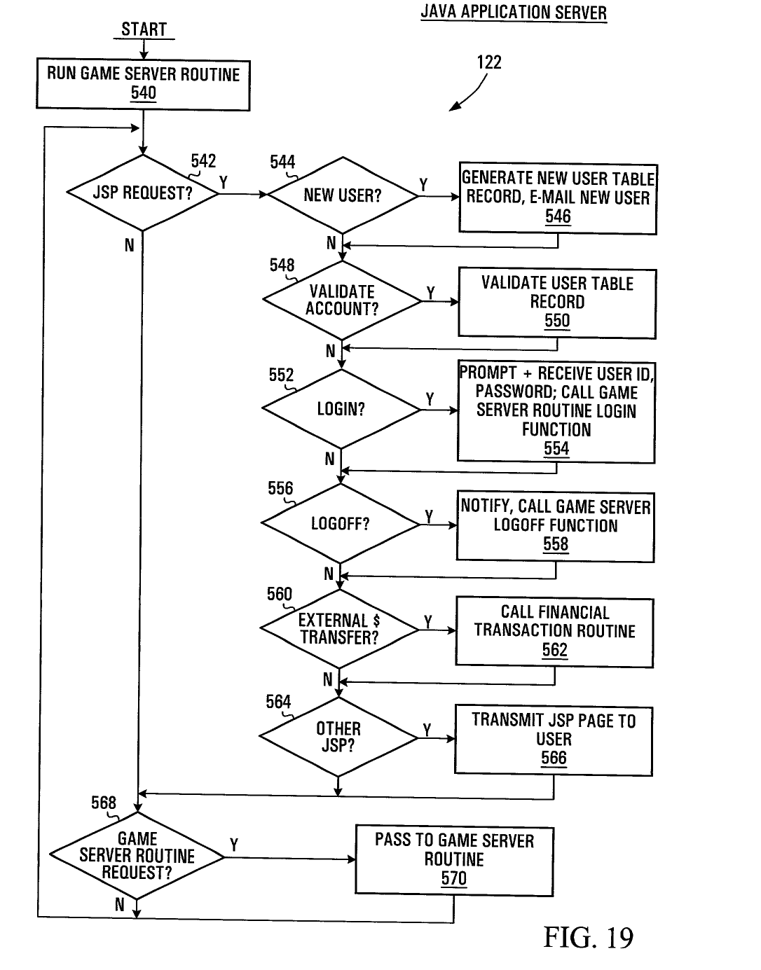

Referring to FIGS. 2, 3, 4, 19 and 20, the Java application server routine is shown generally at 122 in FIG. 19. In this embodiment, the Java application server routine directs the processor circuit 52 to respond to certain Java commands and selection signals received from any of the clients 66, and to pass other commands to the logic of the user session object 140 corresponding to the client from whom the signals originated, for response.

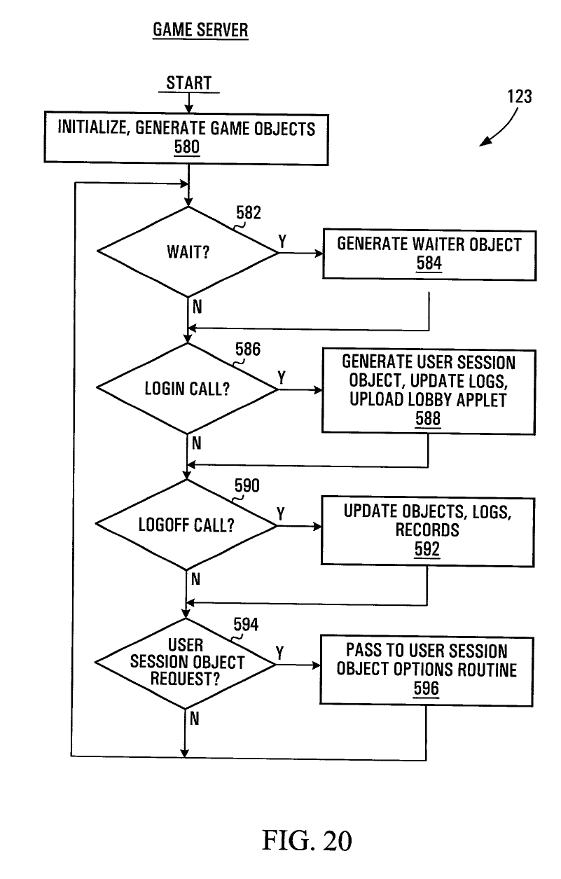

In this embodiment, the Java application server routine 122 begins with a first block 540 of codes, which directs the processor circuit 52 to commence execution of the game server routine 123 shown in FIG. 20. Effectively, as discussed below in the context of the block 580 of the game server routine 123, this results in an initialization of the game server 54, and creation of various game objects in the RAM 88.

Block 542 then directs the processor circuit 52 to determine whether signals including a uniform resource locator (URL) identifying a Java Server Page (.jsp) resource have been received via the network 64 from any of the clients 66, indicating a request to download a corresponding .jsp Java server page identified by the URL and to execute any instruction codes contained therein.

If so, block 544 directs the processor circuit 52 to determine whether such signals represent actuation of a “new user” option, and if so, block 546 directs the processor circuit to generate a new user record 200 in the user table 102 shown in FIG. 4. Block 546 then directs the processor circuit to prompt the user to enter a unique user ID and a corresponding password, and directs the processor circuit to store the entered password in the password field 204 of the new user record 200. Block 546 further directs the processor circuit to store a value representing a pre-defined amount of play money, such as $100 for example, in the play money field 208, and to store the current time and date in the creation date field 220. Block 546 also directs the processor circuit to prompt the user to enter an e-mail address for validation purposes, and directs the processor circuit to store the e-mail address in the e-mail field 221. In this embodiment, the remaining fields 206, 210, 212, 214, 216, 218, 222, 224, 226 and 228 of the newly-generated user record 200 are left empty at the time the record is generated.

In the present embodiment, block 546 further directs the processor circuit 52 to transmit a “welcome” e-mail to the new user, at the e-mail address stored in the e-mail field 221 of the newly-generated user record 200. The welcome e-mail includes a hyperlink, containing a URL identifying a .jsp resource, that the user may actuate to transmit a validation signal, including the user ID field 202 contents of the new user record, to the game server 54 for account validation purposes.

Thus, in the present embodiment block 548 directs the processor circuit 52 to determine whether such a validation signal including a user ID has been received from the network 64, and if so, to identify the user record 200 whose user ID field 202 contents match the user ID included in the validation signal. Block 550 then directs the processor circuit to validate the user's account, by storing the current time and date in the valid date field 222 of the identified user record 200, and by storing a value representing an active account in the status field 228.

In this embodiment, block 552 directs the processor circuit 52 to determine whether signals representing a login request have been received via the network 64 from any of the clients 66, and if so, block 554 directs the processor circuit 52 to prompt the client from which the login request was received to supply a user ID and password. In response to receiving signals from the client representing the user ID and password, block 554 directs the processor circuit to call a login function of the game server routine 123 shown in FIG. 20, to process the login request (the login function of the game server routine is discussed in greater detail below, in the context of block 588 of the game server routine). Block 554 directs the processor circuit to forward to the game server routine 123, a message including the user-supplied user ID and password, along with identifications of three .jsp pages, one of which is to be presented to the user, depending on the success or failure of the login attempt. More particularly, in this embodiment the .jsp pages include the casino “lobby” screen which is to be presented to the user in the event of a “pass” or successful login, a “bad user information” .jsp page that is to be presented in the event that the user ID and/or password do not match those of a registered user, and an “already logged in” .jsp page that is to be presented if the user is already logged onto the game server 54. Block 554 directs the processor circuit to await return by the login function of the game server of an identification of one of these three .jsp pages, and to then transmit signals to the user representing the particular jsp page identified by the login function of the game server routine.

Following execution of blocks 552 or 554, block 556 directs the processor circuit 52 to determine whether signals representing a logoff command have been received from the user, via the network 64. In this regard, such a logoff command may be generated by the user by either actuating a logoff command in a .jsp page being viewed by the user, or alternatively, by closing the user's browser window, which in this embodiment results in automatic generation of a logoff request.

If a logoff request is received, block 558 and the game server routine 123 cooperate to direct the processor circuit to log the user off, as follows. In the case of an active logoff command, block 558 directs the processor circuit 52 to transmit a .jsp page to the user, to prompt the user to confirm his or her desire to log off, and proceeds further only upon receiving signals from the user confirming the intention to log off. Block 558 then directs the processor circuit 52 to call a logoff function of the game server routine 123 shown in FIG. 20, as discussed in greater detail in connection with block 588 of the game server routine. The processor circuit is directed to pass a message to the logoff function of the game server routine, including the user ID of the user who has requested to log off. The logoff process is then implemented by the processor circuit under the direction of the game server routine and the logic of the user session and player session objects, as discussed in greater detail below in connection with block 588 of the game server routine.

Following execution of block 556 or block 558, block 560 directs the processor circuit 52 to determine whether the processor circuit has received signals via the network 64 from the user representing a request to transfer funds into (or out of) the game server 54 from (or to) an external source (such as a credit card provider or a bank account for example). If so, block 562 directs the processor circuit 52 to call the financial transaction routine 126 shown in FIG. 3, to execute a secure on-line financial transaction.

Alternatively, however, other financial transaction routines may be substituted. In this embodiment, the user may use the financial transaction routine to deposit funds from the external source into the user's game server account, or more particularly, into the real money field 206 of the user record 200 whose user ID field 202 contents match those of the user ID field 380 of the user session object 140 of the user in question. Alternatively, the user may transfer funds out of the user's real money field 206 to the external source. To facilitate such transactions, block 562 directs the processor circuit 52 to transmit a .jsp page (not shown) showing the user's current balance (as indicated by the real money field 206 contents), and providing a plurality of fields in which the user may enter information required for the transaction, such as the transaction amount, the user's credit card or bank account information, etc. The .jsp page further includes a “confirm transaction” button, which when actuated, directs the local client processor circuit to transmit such information along with an identification of a further .jsp page to the game server 54. Block 530 of the web server routine 120 directs the processor circuit to pass this information to the Java application server routine 122, in response to which the Java logic of the identified .jsp page then directs the processor circuit to supply the user-supplied information to the financial transaction routine to communicate over the network 64 to carry out the transaction. Block 562 directs the processor circuit 52 to await receipt of a transaction confirmation signal from the financial transaction routine indicating success or failure of the transaction, in response to which block 562 directs the processor circuit to present either a success or failure page to the user.

In the case of a successful transaction, referring to FIGS. 2, 3, 4, 5, 10, 11, 12, 15 and 19, in this embodiment block 562 directs the processor circuit 52 to define a new transaction log record 480 in the transaction log 130 shown in FIG. 15. Block 562 directs the processor circuit to store the time and date of the transaction in the transaction time field 482 of the new transaction log record, and further directs the processor circuit to copy the next available transaction number global value from the global values table 160 to the transaction number field 484 of the newly-generated transaction log record 480, and to increment the next available transaction global value in the global values table. Block 562 further directs the processor circuit to copy the user ID field 380 contents of the current user session object 140 to the user ID field 486, and if the user session object 140 includes a defined player session object 142 (i.e., if the user has entered a room to play or watch a game), the processor circuit is further directed to copy the contents of the game ID field 392 to the game ID field 490. Block 562 further directs the processor circuit to store a value in the transaction type field 488 representing the type of transaction (in this case an external deposit from an external source, or an external withdrawal to an external source), a value in the amount field 492 representing the amount of the transaction, and a further value in the payment method field 494 representing the payment method used (such as on-line banking, Visa, MasterCard, etc.). Block 562 further directs the processor circuit to copy the contents of the real money field 206 of the user to the balance field 496, to indicate the running “balance” of the user's real money field 206 immediately following the deposit to (or withdrawal from) the real money field 206 from (to) the external source. In addition, block 562 directs the processor circuit to determine whether the active date field 224 of the user record 200 corresponding to the user is blank, and if so, to write the current time and date to the active date field 224, to indicate the time and date at which the user first deposited real money into his or her real money field 206. In this embodiment, block 562 also directs the processor circuit to update the contents of the house balance field 370 shown in FIG. 10, by adding the contents of the amount field 492 if the contents of the transaction type field 488 indicate a deposit from an external source, or conversely, by subtracting the amount field contents if the transaction field contents indicate a withdrawal to an external source.

In addition, in the present embodiment block 562 directs the processor circuit to determine whether the payment method field 494 contents indicate a type of payment method for which the proprietor of the game server 54 must pay a fee (such as Visa, MasterCard or most other credit cards, for example), by reference to a look-up table (not shown). If so, then block 562 directs the processor circuit 52 to effectively pass the fee on to the user. To achieve this, block 562 directs the processor circuit to generate another new transaction log record 480 as described above, corresponding to the same user, with a new transaction number, and with transaction type field 488 contents indicating a user fee charged by the proprietor of the game server to the user, to compensate the proprietor for the cost of the transaction. Block 562 further directs the processor circuit to determine a fee amount, by using the payment method field 494 contents to look up a corresponding record in the look-up table (not shown) that indicates whether the fee is a specified flat fee or a percentage. Block 562 directs the processor circuit to determine the amount of the fee, either as the specified flat fee stored in the look-up table or as a specified percentage stored in the look-up table of the amount stored in the amount field 492 of the previously-generated transaction log record 480 for this user. Block 562 directs the processor circuit to store the amount in the amount field 492 of the new transaction log record 480, to subtract the stored amount from the real money field 206 of the user record 200 of the user, to add the stored amount to the contents of the fees paid field 210 of the user record, and to copy the contents of the real money field 206 (following subtraction of the fee) to the balance field 496 of the new transaction log record. Similarly, block 562 directs the processor circuit to add the stored fee amount to the contents of the total fees field 372 of the house values table 114.

It will be appreciated that in addition to the functions described at blocks 544 through 562, numerous other .jsp-related requests may be processed by the Java application server routine 122, as illustrated generally by blocks 564 and 566, which direct the processor circuit 52 to respond to requests for various .jsp resources, by transmitting representations of the identified .jsp resources, and executing instruction codes contained therein.

Following execution of block 542 or any of blocks 544 through 566, block 568 directs the processor circuit 52 to determine whether client-initiated communication signals have been received from any of the clients 66 via the network 64, representing commands or requests that are to be forwarded to the game server routine 123 for response. If so, block 570 directs the processor circuit to pass such communication signals to the game server routine 123 shown in FIG. 20.

The processor circuit is then directed back to blocks 542, to continue processing as described above.

Game Server Routine

Referring to FIGS. 2, 3, 4, 6, 7, 8, 11, 15, 19, 20 and 23, the game server routine is shown generally at 123 in FIG. 20. Generally, the game server routine 123 configures the processor circuit 52 to initialize the game server 54, to respond to waiting list requests from users, to respond to login or logoff calls from the Java application server routine 122, and to pass various client-initiated communications to the logic of the user session object 140 for response. It will be recalled that the game server routine 123 is automatically executed under the direction of block 540 of the Java application server routine 122 shown in FIG. 19, when the game server 54 is started up.

In this embodiment, the game server routine 123 begins with a first block 580 of codes, which directs the processor circuit 52 to initialize the game server 54 and to define a plurality of game objects 150, each game object corresponding to a particular respective one of the game records 260 in the games table 106 shown in FIG. 6. For ease of illustration, only a single game object 150 is shown in FIG. 3 and primarily discussed herein, however, it will be appreciated that a large number of game objects 150 corresponding to a large number of game records 260 may be defined if desired, to provide a large number of games available to play on the game server 54. In this embodiment, initializing includes defining the contents of the global values table 160 in the RAM 88, which in this embodiment include next available global values corresponding to the hand number field 322 and the transaction number field 484. Block 580 directs the processor circuit to determine the next available global values for each of these entities by reading the contents of the aforementioned fields, identifying the highest value stored in each field, and by storing the next highest incremented number in the corresponding global values table field.

Referring to FIGS. 2, 3, 6, 7, 13 and 20, to define the game objects 150 in this embodiment, for each game record 260 shown in FIG. 6, block 580 directs the processor circuit 52 to copy the contents of the game ID field 262, the game type field 264 and the configuration ID field 266 to the game ID field 424, the game type field 420 and the configuration ID field 422 of the corresponding game object 150 shown in FIG. 13. The hand number field 426 of the game object 150 is initially undefined until a hand is commenced.

Block 580 further directs the processor circuit 52 to copy the contents of the real money flag field 272 of the game record 260 to the rake flag field 428 of the game object 150, so that the game object 150 will only direct the processor circuit to take a “rake” of the pot of the game if real money is being wagered at that game.

In this embodiment, the player lists 430 are initially empty, although these fields will be gradually filled up as new players join the game, as discussed in greater detail below in the context of the wait watcher routine 129.

In the present embodiment, block 580 directs the processor circuit 52 to initially set the contents of the current position field 438 and the previous position field 440 of the game object equal to 0 and −1 respectively, to indicate a seat position that is one seat to the dealer's left, and to indicate the dealer's seat, respectively.

Block 580 in this embodiment further directs the processor circuit 52 to define the deck object 442 of the game object 150, in an initially unshuffled state (numbered 0-51).

In this embodiment, both the hand-in-progress and round-in-progress flag fields 446 and 448 are initially set inactive or false to indicate that neither a hand nor a round is in progress.

In this embodiment, block 580 further directs the processor circuit to address the game configuration record 290 in the game configuration table 108 whose configuration ID field 292 contents match those of the configuration ID field 266 of the currently addressed games record 260. Block 580 then directs the processor circuit to copy the contents of the remaining fields 294, 296, 298, 300, 304, 306 and 308 of the game configuration record 290 to the corresponding similarly-named fields 452, 454, 456, 458, 462, 464 and 466 of the game object 150, respectively.

In this embodiment, the state field 468 and the pot field 472 of the game object 150 are initially empty.

After generating such a game object 150 for each of the games records 260 at block 580, block 582 directs the processor circuit 52 to determine whether a signals representing a “wait” request have been received from the local client processor circuit under the direction of the lobby applet 127 (or the game applet 128, if the user has already entered the room to watch), representing a request from the user to be placed on a waiting list for a game. Such signals include the unique game ID identifying the game in relation to which the user initiated the “wait” request.

If such a wait request has been received, the user is placed onto a waiting list, as follows. In response to actuation by the user of the “wait” selection corresponding to a particular game, the lobby applet 127 (or the game applet 128, if the user is already in a room) directs the local client processor circuit to prompt the user to specify whether the user wishes to be placed on a waiting list for “this game” in particular, or alternatively, for “any game like this game”.

If the user selects “this game”, the relevant applet 127 or 128 directs the local client processor circuit to transmit signals indicating a selection of the particular game to the game server 54, via the network 64. Block 584 configures the processor circuit 52 to respond by generating a waiter object such as that shown at 170 in FIG. 14. To achieve this, block 584 directs the processor circuit 52 to copy the contents of the user ID field 380 and session ID field 382 of the user session object 140 to the user ID field 473 and session ID field 474 of the waiter object. Similarly, the processor circuit copies the unique game ID value corresponding to the game that the user has selected to “wait” for (as identified in the signals transmitted by the local client processor circuit) to the game ID field 475 of the waiter object. If desired, the processor circuit 52 may further locate the game configuration record 290 corresponding to the selected game and fill in the contents of the fields 476, 477, 478 and 479 from the game and game configuration records, although it will be appreciated that this information is unnecessary where the user has selected a specific game. The processor circuit 52 then stores a pointer to the location in the RAM 88 of the newly-created waiter object 170, in the next available position in the waiters list 164 shown in FIG. 3.

Alternatively, if the user selects “any game like this game”, the lobby applet 127 (or game applet 128) directs the local client processor circuit to further prompt the user to specify any minimum number of players that the user wishes to play against. In this regard, although the minimum number of players for a particular game might be three for example, the user might not wish to play a game unless there are seven other players, for example, to increase the pot size. In response to user input either specifying such a minimum number of players or declining to do so, the lobby applet 127 directs the local client processor circuit to transmit signals to the game server 54 identifying the selected game, indicating a selection of any game that is similarly-configured to the selected game, and specifying the user-selected minimum number of players, if applicable. Block 584 directs the processor circuit 52 to respond by generating a waiter object 170 with user ID field 473 and session ID field 474 contents copied from the user ID field 380 and session ID field 382 of the user session object 140. However, in this case, the processor circuit 52 stores a value of −1 in the game ID field 475 of the waiter object 170, to indicate that no specific game is required. The processor circuit 52 uses the game ID of the selected game to locate the game object 150 corresponding to the selected game and to copy the contents of the configuration ID field 422, the game type field 420, and the number of cards field 456 to the similarly-named fields 476, 477 and 478 of the waiter object 170. If the signals received from the lobby applet further included a user-specified minimum number of players, then the processor circuit stores this number in the minimum number of players field 479 of the waiter object; otherwise, the processor circuit stores a value of zero in the corresponding field 479. The processor circuit 52 then stores a pointer to the location in the RAM 88 of the newly-created waiter object 170, in the next available position in the waiters list 164 shown in FIG. 3.

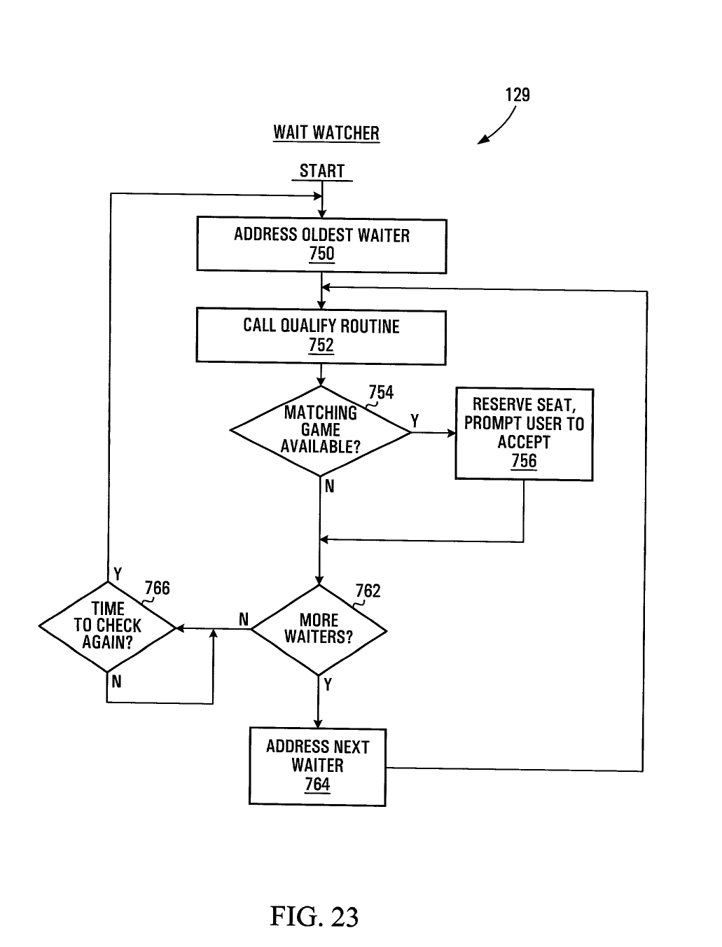

Once such a waiter object has been created, the wait watcher routine 129 shown in FIG. 23 will then direct the processor circuit 52 to attempt to seat the player when a seat matching the player's criteria becomes available, as described in greater detail below.

Following execution of block 582 or 584, block 586 directs the processor circuit 52 to determine whether a login call has been received from block 554 of the Java application server routine 122 shown in FIG. 19. It will be recalled that such a login call includes a user-supplied user ID and password, along with identifications of three possible .jsp pages to be transmitted to the user who is attempting to log in, in the case of a successful login, a failed login due to non-matching user ID or password, and a failed login due to the user already being logged in, respectively.

If such a login call from the Java application server routine has been received, block 588 directs the processor circuit 52 to create a connection log record 500 in the connection log 132 shown in FIG. 16, to store the client-supplied user ID and password in the user ID and password fields 504 and 506 respectively of the new connection record, and to store the current time and date in the time stamp field 502 of the record. Block 588 further directs the processor circuit to confirm that the user is not already logged on, by comparing the contents of the user ID fields 380 of any existing user session objects 140 in the RAM 88 to the client-supplied user ID to confirm that no such contents match the user-supplied ID. If any such user session object is found then block 588 directs the processor circuit to pass an identification of the “already logged on” .1542 jsp page back to block 554 of the Java application server routine 123, in response to which block 554 transmits the identified “already logged on” page to the user, to notify the user that he or she is already logged on, and that further access is therefore denied. The processor circuit is also directed to store an inactive bit in the success flag field 508 of the new connection log record 500.

If the user was not already logged on, block 588 directs the processor circuit to locate and address a user record 200 in the user table 102 shown in FIG. 4 whose user ID field 202 contents match the client-supplied user ID.

If the client-supplied password matches the contents of the password field 204 of the addressed user record, then block 588 directs the processor circuit 52 to store an active bit in the success flag field 508 of the new connection log record 500, and to generate a new session log record 510. The processor circuit is directed to store the client-supplied user ID in the user ID field 512, and to store the current time and date in the start time field 514 of the session log record. Block 588 further directs the processor circuit to generate a new user session object such as that shown at 140 in FIG. 11, to store the client-supplied user ID in the user ID field 380 of the new user session object. The processor circuit is then directed to generate a large random number and to store the random number in the session ID field 382 of the newly-generated user session object 140. Block 588 further directs the processor circuit to pass the identification of the “pass” .jsp page, which in this embodiment is an identification of a jsp page representing a casino “lobby” screen, to block 554 of the Java application server routine 123, in response to which block 554 transmits signals representing the lobby screen to the requesting client 70, via the network 64, to cause display at the client of the lobby screen, providing the player 60 with a plurality of options, including options to enter a room or table, transfer funds, or view other web-pages or other sites available for viewing on the game server. Block 588 also directs the processor circuit to upload the lobby applet 127 via the network 64 to the client from which the login request was received, such as the client 70 shown in FIG. 2 for example. The lobby applet 127 is then executed by the processor circuit 74 of the requesting client 70.

If, however, the user-supplied password did not match the contents of the password field 204, or if no user record containing the supplied user ID could be located, block 588 directs the processor circuit to store an inactive bit in the success flag field 508 of the newly-generated connection log record 500, and to pass an identification of the “bad user information” .jsp page to block 554 of the Java application server routine, in response to which block 554 directs the processor circuit to transmit signals via the network 64 to the requesting client 70 representing the “bad user information” .jsp page, notifying the client that access to the game server 54 has been denied.

Following execution of block 586 or 588, block 590 of the game server routine then directs the processor circuit 52 to determine whether a logoff call has been received from block 558 of the Java application server routine 122 shown in FIG. 19. It will be recalled that such a logoff call includes the user ID of a user who has requested to log off of the game server 54, either expressly or by closing the user's browser window. If such a logoff call from the game server routine has been received, block 592 directs the processor circuit to execute a logoff function of the game server routine.

To achieve this, in the present embodiment, block 592 directs the processor circuit 52 to locate the user session object 140 in the RAM 88 whose user ID field 380 contents match the user ID of the user who is to be logged off. Block 592 directs the processor circuit to invoke a clean-up function (not shown) of the located user session object 140.

The user session object clean-up function directs the processor circuit to determine whether the user session object 140 of the user includes a pointer to a defined player session object 142, indicating that the user is still in a room. If so, then the user session object clean-up function directs the processor circuit to invoke a clean-up function (not shown) of the player session object 142.

The player session object clean-up function directs the processor circuit 52 to address the player session object 142, as well as the game object 150 identified by the game object link field 394 of the player session object, and to determine whether the user is in the middle of playing a hand that is in progress. To determine this, the processor circuit is directed to determine whether the seated field 432 contains a link to the player session object 142, the contents of the hand-in-progress flag field 446 are active, and the ante flag field 410 contents are true. If these conditions are not conjunctively true, i.e., if the user is not presently playing a hand in progress, then, as a log-off is deemed to include the act of leaving a room, the processor circuit is directed to carry out other actions associated with leaving a room, such as effectively moving any money the player may have in the room to the player's main account on the game server, for example. To achieve this, the processor circuit is directed to read the contents of the rake flag field 428 of the game object identified by the contents of the game object link field 394 of the player session object 142, to determine whether the money used in this room is “real” money or “play” money. The processor circuit is then directed to locate and address the user record 200 corresponding to the user (i.e., matching user ID fields 202 and 380) and to locate and address the user game record 240 corresponding to the user and the game (i.e., fields 242 and 246 match fields 380 and 392 respectively). The player session object clean-up function then directs the processor circuit to increment the contents of either the real money field 206 (if the rake flag field 428 indicates real money) or the play money field 208 (if the rake flag field indicates play money) by the contents of the game balance field 248, and to then delete the user game record 240 from the user game table 104. The processor circuit 52 is further directed to generate a new transaction log record 480, in a manner similar that described in greater detail below in connection with block 562, with the exception that the transaction type field 488 contents are set to a value indicating an internal transfer from a room on the game server to the user's user record 200. The player session object clean-up function is then completed.

Upon completion in the above manner of the player session object clean-up function, the processor circuit 52 is directed back to the user session object clean-up function, which directs the processor circuit to effectively “delete” the player session object 142, by removing any links to the player session object 142 in the user session object 140 and in the seated or watching fields of the player lists 430 of the game object 150, and by deleting any instances of the player's user ID in the reserved field 436. It will be appreciated that in a Java environment, actual deletion of the player session object 142 from memory will not occur until all links to the player session object have been deleted. In this embodiment, the user session object clean-up function further directs the processor circuit to effectively remove the player from any waiting lists, by deleting any pointers stored in the waiters list 164 to any waiter objects 170 corresponding to the player.

Similarly, upon completion in the above manner of the user session object clean-up function, the processor circuit is directed back to block 592 of the game server routine 123, which directs the processor circuit to store the end time field 516 contents in the session log record 510 corresponding to the user, and to effectively “delete” the user session object 140 from memory, in a similar manner to the deletion of the player session object 142.

Conversely, if, upon invoking the player session object clean-up function, it was determined that the user is presently playing a hand that is in progress, then the player session object clean-up routine further directs the processor circuit to determine whether the user has already committed to be “in” for the hand, by determining whether the in flag field 408 contents are active. If they are not active, then the processor circuit is directed to effectively “fold” the player, as discussed in greater detail below in connection with blocks 914 and 915 of the player session object options routine 143. The processor circuit is then directed to proceed to execute the remainder of the player session object and user session object clean-up functions and is directed back to block 592 to effectively delete the user session object 140, as described above.

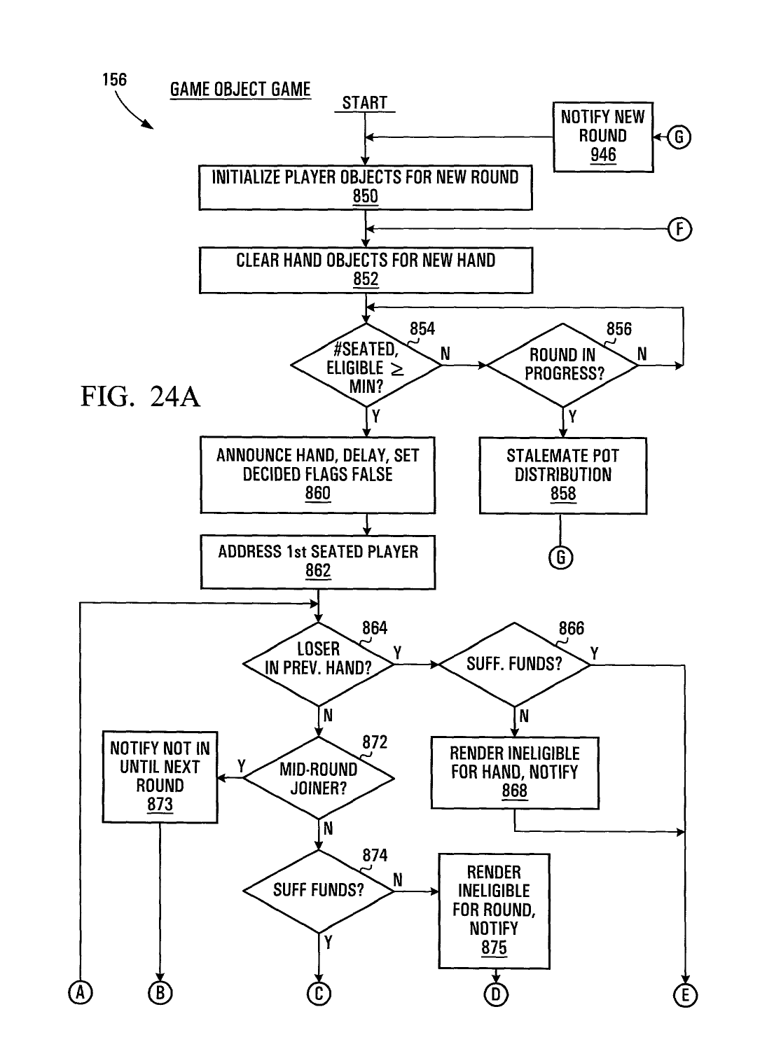

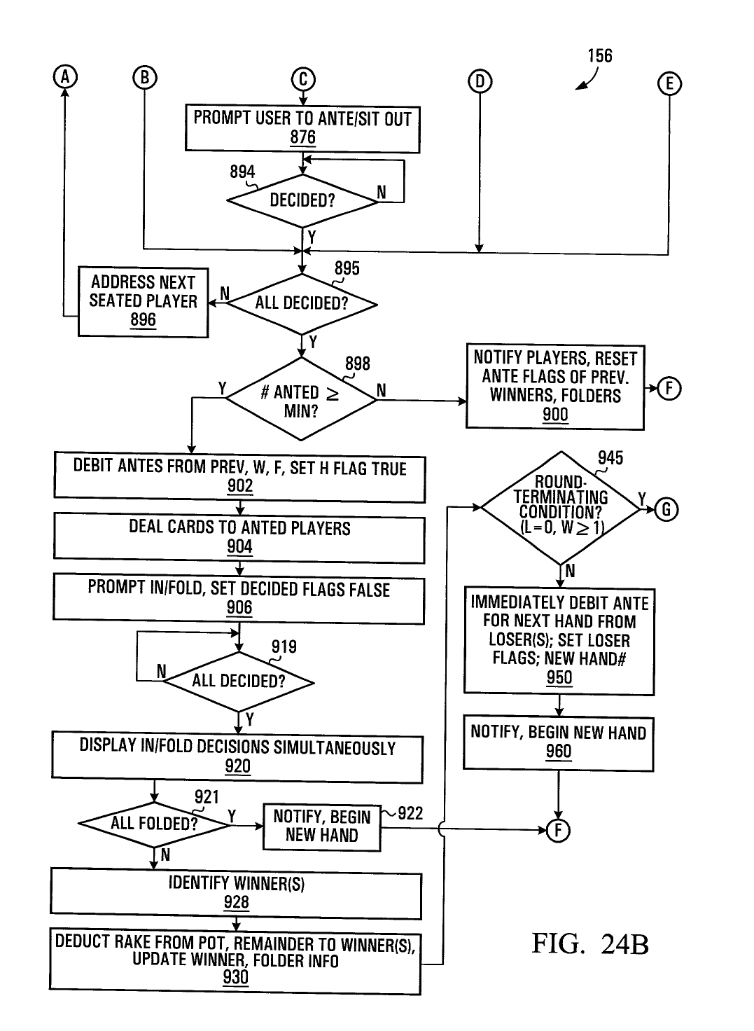

If, however, it is determined that the player has already committed to be “in” for a hand in progress, then if desired, the player session object clean-up function may direct the processor circuit 52 to prompt the user to confirm his or her intention to leave in the middle of a hand to which he or she has already committed. If the user does wish to proceed (or if no such prompt is given in a particular embodiment), then the player session object clean-up function proceeds in a manner similar to that described above, with one main exception: in this case, the link to the player session object 142 stored in the seated field 432 of the game object is not deleted, but is merely flagged for deletion following the end of the present hand, by setting the contents of a deletion flag sub-field (not shown) of the seated field 432 active. It will be appreciated that due to the nature of the Java environment, because the link to the player session object 142 in the game object 150 is not immediately deleted, the player session object 142 will continue to exist in the RAM 88 until the last link to it is deleted. Thus, the player session object 142 will continue to exist in the RAM 88, so that at the end of the present hand, if the player loses, the processor circuit 52 will nevertheless be successfully directed to automatically debit the ante for the next hand from the player's account, as discussed in greater detail below in connection with block 950 of the game object game routine 156 shown in FIG. 24. Conversely, if the player wins, the player's account will be credited with his or her winnings, at described below in connection with block 930 of the game object game routine. It is noted that in this embodiment, the game object game routine includes additional logic (not shown) that directs the processor circuit to determine, each time the hand-in-progress flag field 446 contents are set from active to inactive, whether each entry in the seated field 432 has been flagged for deletion at the end of the hand, when winnings have already been credited or losses debited, and if so, to delete the corresponding entry. Advantageously, therefore, once a player has committed to be “in” for a hand, then any interruption or disconnection of the player from the game server, whether accidental or intentional, will not preclude the player from collecting his or her winnings, and conversely, will not prevent the player from being debited for any losses incurred.

If the processor circuit, upon execution of the clean-up function of the user session object, determines that the user was not in any “room” or table when the logoff request was made, (i.e., if no player session object 142 corresponding to the user who is to be logged off exists), the processor circuit is directed back to block 592, to update the contents of the end time field 516 of the session log record 510, and to effectively delete the user session object 140 from the RAM 88.

Following execution of block 590 or 592, block 594 directs the processor circuit 52 to determine whether client-initiated communication signals representing a command or request from a user, that is to be processed by the logic of the corresponding user session object 140, has been received (it will be recalled that such signals are received by the processor circuit under the direction of the web server routine 120, which passes such signals to the Java application server routine 122, which in turn passes the signals to the game server routine 123). If so, block 596 directs the processor circuit to pass such signals to the user session object options routine 141 of the user session object 140 corresponding to the user who communicated the signals to the game server 54.

Following execution of block 594 or 596, the processor circuit 52 is directed back to blocks 582, 586, 590 and 594, to continue awaiting and responding to waiting list requests, login and logoff calls, and user session object commands, as described above.

User Session Object Options Routine

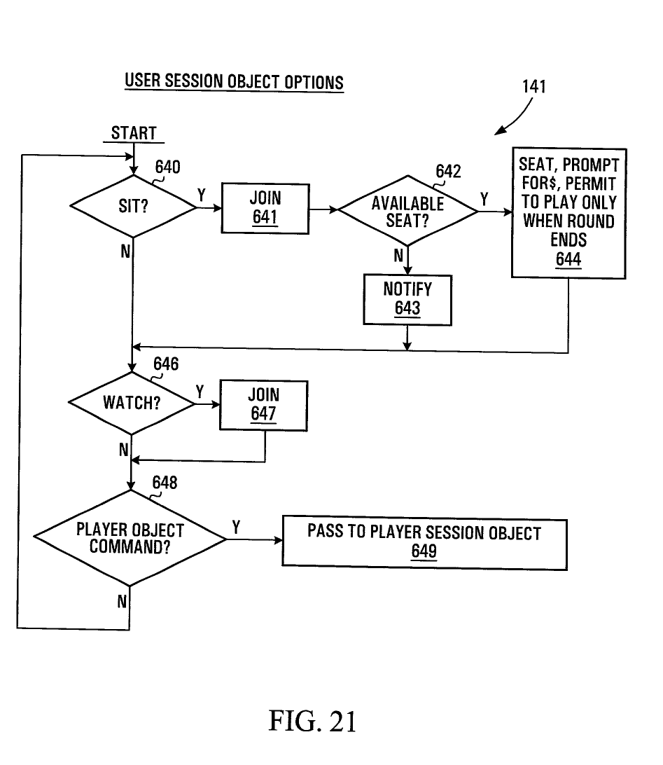

Referring to FIGS. 2, 3, 4, 11, 14 and 21, the user session object options routine is shown generally at 141 in FIG. 21. Generally, the user session object options routine directs the processor circuit 52 to respond to various optional selections or commands from a user who has logged onto the game server 54 and who is thus identified by a corresponding user session object 140 shown in FIG. 11. (In this sub-heading, “the user” refers to a particular user identified by a particular user session object 140 being presently discussed for illustrative purposes.) In this regard, a number of such optional selections or commands may be available to a user at any given time.

For example, in this embodiment, the lobby screen transmitted to the client at block 626 above includes a plurality of command selections. In response to actuation of such command selections by the user of the client, the lobby applet 127 executing on the client directs the local client processor circuit to transmit corresponding command or selection signals to the game server processor circuit 52. More particularly, in this embodiment the lobby screen includes respective links to each of the “rooms” or tables at which respective games available on the game server 54 are being played. The user may actuate such links in order to transmit a request to the game server 54 to “sit” at the table to play the game, “enter” the room to merely watch the game, or to “wait” for a free seat at the table. In this embodiment, therefore, the user session object options routine configures the processor circuit 52 to respond to such “sit” or “enter” requests to enter a room, as described below (it is noted that “wait” requests are dealt with by the game server routine 123, as described above).

In addition to generating such “sit” or “enter” requests from the lobby, in the present embodiment, a “sit” request may be generated by a user who has already “entered” a room as a “watcher” by clicking on a representation of a particular displayed unoccupied seat, in which case the “sit” request signals transmitted by the client include an identification of a specific seat number at the table, corresponding to the seat which the player “clicked”. Similarly, in this embodiment, a “sit” request may be generated by a user who was previously placed on a waiting list and who has accepted a seat that has been offered to the user, as discussed below in connection with the wait watcher routine 129, in which case the “sit” request also includes an identification of a the specific seat number that was reserved for the user.

In this embodiment the user session object options routine 141 begins with a first block 640 of codes which directs the processor circuit 52 to determine whether “sit” request signals from a user, including an identification of a selected game object 150, have been received via the network 64, and if so, block 641 directs the processor circuit 52 to execute a “join” command, which initially places the user in the room as a watcher.

To achieve this, block 641 first directs the processor circuit 52 to determine whether a player session object 142 corresponding to the user and the requested game already exists and is linked to the user session object 140, and if not, to generate one (the player session object would already exist if the user was already in the room as a “watcher” when the sit request was initiated). In this embodiment, only one player session object 142 is permitted within a user session object 140, or in other words, the user is permitted to be in only one “room” at a time. (Alternatively, however, in other embodiments a plurality of player session objects may be defined for each player, effectively allowing each player to watch or play more than one game at once.) Block 641 directs the processor circuit to define the new player session object 142 to have contents as described in greater detail above under the heading “Player Session Object”, with the flags in the decided flag field 406, the in flag field 408 and the ante flag field 410 initially set inactive, the contents of the seat number field 412 being initially undefined, and the contents of the next ante field 414 being initially set to a default value, which in this embodiment is the default value stored in the default ante field 458 of the game configuration field 450 of the corresponding game object 150 identified by the contents of the game object link field 394 of the player session object 142. Block 641 further directs the processor circuit to store, in the watching field 434 of the player lists 430 of the corresponding game object 150, a link to the player session object 142.

In addition, block 641 directs the processor circuit 52 to upload the game applet 128 to the user's local client processor circuit for execution thereon.

Block 642 then directs the processor circuit 52 to determine whether the received sit request signals include an identification of a specific seat number (for example, where the user was already in the room as a watcher and clicked on a specific vacant seat to generate the sit request signals, or where the user generated the sit request signals by accepting an offer of a seat that was reserved for the user by the processor circuit under the direction of the wait watcher routine 129, as discussed below). If the sit request signals include an identification of a specific requested seat number, block 642 directs the processor circuit to confirm that the requested seat is available. More particularly, block 642 directs the processor circuit to confirm that the seat is unoccupied, by confirming that the sub-field of the seated field 432 of the game object 150 corresponding to the requested seat is empty. Block 642 further directs the processor circuit to confirm that the requested seat is not reserved for anyone else, by confirming that the sub-field of the reserved field 436 is either empty or contains a user ID matching that of the requesting user (as stored in the user ID field 380 of the user session object 140). If the requested seat is available, the processor circuit is directed to block 644 to seat the user, as described below. Alternatively, if the seat is not available, block 643 directs the processor circuit to notify the user and to leave the user in the room as a watcher.

Alternatively, if the sit request signals did not include a specific seat number (for example, where the user initiated the sit request from the lobby), block 642 directs the processor circuit 52 to determine whether there is any available seat at the game defined by the game object 150 identified by the received sit request signals. To achieve this, block 642 directs the processor circuit to examine each pair of sub-fields of the seated field 432 and the reserved field 436 corresponding to each respective seat number of the game, and to determine whether seat is both unoccupied (i.e., seated field 432 sub-field is empty) and unreserved (i.e., reserved field 436 sub-field is either empty or contains the user ID of the user making the sit request). If no such available seat exists, block 643 directs the processor circuit to notify the user that there are no available seats in the room, and the user is thus left as a “watcher” of the game in that room.

If at block 642 an available seat has been located for the user, then block 644 directs the processor circuit 52 to seat the player, by storing a link to the player session object 142 in the seated field 432 of the game object, or more particularly, in the particular seated field sub-field corresponding to the available seat. Block 644 further directs the processor circuit to delete the link to the same player session object stored in the watching field 434 of the game object 150 corresponding to the game selected by the user. In addition, if the sub-field of the reserved field 436 corresponding to the player's seat contains the player's user ID, block 644 directs the processor circuit to delete the user ID from the reserved field 436, to unreserve the seat, which is now occupied. In addition, block 644 directs the processor circuit to determine whether the user is presently identified in the waiters list 164 (this may arise, for example, if the user decides to “sit” at one table while the user is still on the waiters list for another table or for a different game configuration) and if so, block 644 directs the processor circuit to remove the player from the waiting list, by deleting the identification in the waiters list 164 of the player's waiter object 170. Block 644 further directs the processor circuit to store a value representing the seat number of the seat which the player has just “sat” in, in the seat number field 412 of the player session object 142.

In this embodiment, however, merely being seated at a table does not necessarily entitle the player to play at the table. Rather, due to the advantageous way in which the pot grows from hand to hand within a round in the present embodiment, new players are not permitted to join in while a round of the game is in progress. Accordingly, in the present embodiment, block 644 effectively configures the processor circuit to permit the new player to join the game only when a round of the game has ended, or in other words, to prevent the newly-seated player from playing any hands in a round that was already in progress when the newly-seated player first sat at the table.

To achieve this, in the present embodiment block 644 directs the processor circuit 52 to determine whether the round-in-progress flag field 448 of the game object 150 is active, indicating that a round of the game is in progress. If so, block 644 directs the processor circuit to set the contents of the next ante field 414 of the player session object 142 of the newly-seated player equal to −1, and to set the contents of the player's ante flag field 410 equal to zero (false). As will be discussed below in the context of the game itself, this combination of contents of the fields 410 and 414 prevents the newly-seated player from receiving cards until the current round has ended.

Alternatively, if it is determined that a round is not in progress, block 644 directs the processor circuit 52 to set the contents of the next ante field 414 of the newly-seated player's player session object 142 equal to the default ante amount specified by the default ante field 458 of the game object 150, and to set the contents of the ante flag field 410 false. As will be discussed below, when the first hand of the next round begins, this configuration will allow the player to opt whether to ante in or to sit out for the round.

In this embodiment, block 644 further directs the processor circuit 52 to generate a new user game record 240 in the user game table 104 shown in FIG. 5, whose user ID field 242, game type field 244 and game ID field 246 contents match those of the user ID field 380, the game type field 390 and the game ID field 392, respectively (for example, if the user was already watching the game). Block 644 directs the processor circuit to set the initial contents of the game balance field 248 and the hand start balance field 250 equal to zero.

In addition, in this embodiment block 644 directs the processor circuit 52 to notify the user of the need to actuate a transfer funds command, in order to bring an amount of either real money or play money (depending on which type of money is used in this room) into the room. The transfer funds command is discussed in greater detail below in the context of the player session object options routine 143. In this embodiment, the user is only required to bring funds into a room when the user “sits” at a table, and need not bring funds in merely to watch a game in progress.

Following execution of block 640, 643 or 644, block 646 directs the processor circuit 52 to determine whether a “watch” request has been received via the network 64 from the user, representing a request to “watch” a game at a particular room or table available on the game server 54.

If so, block 647 directs the processor circuit to execute a “join” command, to define a player session object 142 corresponding to the user and the requested game, as discussed above in connection with block 641, with the flags in the decided flag field 406, the in flag field 408 and the ante flag field 410 initially set inactive, the contents of the seat number field 412 being initially undefined, and the contents of the next ante field 414 being initially set to a default value, which in this embodiment is the default value stored in the default ante field 458 of the game configuration field 450 of the corresponding game object 150 identified by the contents of the game object link field 394 of the player session object 142. Block 647 further directs the processor circuit to store, in the watching field 434 of the player lists 430 of the corresponding game object 150, a link to the player session object 142.

Block 647 directs the processor circuit to upload the game applet 128 to the user's local client processor circuit for execution thereon, as described above in connection with block 641.

Following execution of block 646 or 647, block 648 directs the processor circuit 52 to determine whether client-initiated communication signals have been received from a user over the network 64 that correspond to a command that is to be executed by the player session object options routine 143, and if so, block 649 directs the processor circuit to effectively pass such signals to the player session object for response. In this regard, it will be recalled that command signals received from the user via the network 64, that are to be processed by the player session object options routine, are first received by the processor circuit 52 under the direction of the web server routine 120, which directs the processor circuit to pass such signals to the Java application server routine 122, which directs the processor circuit to pass the signals to the game server routine 123, which in turn passes the signals to the user session object options routine 141, for forwarding to the player session object options routine.

The processor circuit 52 continues to await and respond to “sit”, and “watch” commands, and to forward further commands to the player session object options routine, in the above manner.

Player Session Object Options

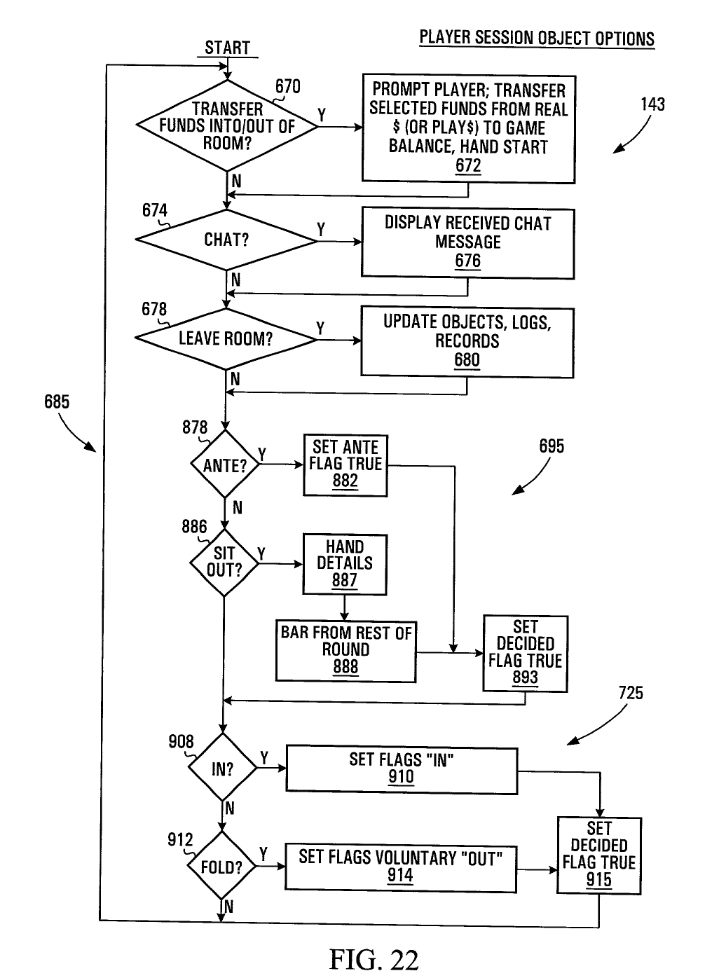

Referring to FIGS. 2, 3, 4, 5, 9, 11, 12, 13, 15, 22 and 24, the player session object options routine is shown generally at 143 in FIG. 22. Generally, the player session object options routine configures the processor circuit to respond to various selections or commands available to a user who has entered a particular “room” at the game server 54, resulting in the creation of a player session object 142 corresponding to the particular player and the particular room, as described above in connection with block 641 of the user session object options routine.

In this embodiment, the player session object options routine 143 begins with a first block 670 of codes, which directs the processor circuit 52 to determine whether signals representing a request to transfer funds from (or to) an internal account on the game server 54 into (or out of) a room have been received from the user, via the network 64. If so, block 672 directs the processor circuit 52 to determine whether the contents of the hand-in-progress flag field 446 are active, as fund transfers into and out of rooms are only permitted between hands in the present embodiment, unless the player has opted to sit out for the remainder of a round, or fold for a given hand.

If a hand is in progress, block 672 further directs the processor circuit to determine whether the user has failed to ante, thereby sitting out for the remainder of the round (in which case the user's player session object 142 has next ante field 414 contents=−1 and ante flag field 410 contents=false), or whether the user has opted to fold at the end of the hand (in which case a hand details record 350 exists in the hand details table 112, whose hand number field 352 contents and user ID field 358 contents match those of the corresponding fields 426 and 380 of the game object 150 and the player session object 142 respectively, and whose transaction type field 360 contents indicate a fold). If the user has not either sat out or folded from the hand in progress, the processor circuit is directed to notify the user that he or she must wait until the end of the hand to transfer funds.

If a hand is not in progress, or alternatively, if a hand is in progress but the user has either sat out of the round or folded from the hand, block 672 directs the processor circuit to determine whether real or play money is used in the room which the user is in, by reading the contents of the rake flag field 428 of the game object 150 identified by the link stored in the game object link field 394 of the player session object 142 (it will be recalled that the rake flag is set active for any games or rooms in which real money is used, and is inactive for play money rooms). Block 672 directs the processor circuit to prompt the user to specify an amount to be transferred, and to indicate whether the amount is to be transferred into or out of the room. If a transfer into the room is specified by the user, block 672 directs the processor circuit to compare the requested amount to the contents of the minimum hand start balance field 466 of the game object 150 identified by the contents of the game object link field 394 of the player session object. If the requested amount is less than the minimum hand start balance, the user is notified that the requested amount is not enough to play a hand in the room. Otherwise, block 672 directs the processor circuit to deduct the requested amount from the real money field 206 (if the rake flag is active) or from the play money field 208 (if the rake flag is inactive), to add the requested amount to the contents of the game balance field 248 of the user game record 240 of the user game table 104 corresponding to the user and the game (i.e., matching user ID fields 242 and 380, and matching game ID fields 246 and 392), and to update the hand start balance field 250 contents by setting them equal to the contents of the game balance field 248 immediately following the transfer. Conversely, a transfer of funds out of the room is implemented in the reverse manner, with funds being subtracted from the game balance field 248 and added to the real money field 206 or play money field 208, depending on whether the rake flag indicates real or play money respectively. For either a transfer into or a transfer out of the room, block 672 further directs the processor circuit to generate a new transaction log record 480 in the transaction log 130 shown in FIG. 15, in a manner similar to that described in greater detail above in connection with block 652 of the user session object options routine 141, with the exception that the processor circuit stores a value in the transaction type field 488 representing either an internal transfer into a room (user game record 240) from the user's main account (user record 200), or an internal transfer out of the room to the user's main account, respectively.

In this embodiment, following execution of blocks 670 and/or 672, block 674 directs the processor circuit 52 to determine whether signals representing a chat message have been received from the user to whom the player session object 142 corresponds, and if so, block 676 directs the processor circuit to transmit signals representing GAME INIT information including the received chat message, to each of the users presently in the room, or more particularly, to each of the clients 66 shown in FIG. 2 identified by links in the seated field 432 and the watching field 434 of the game object 150 identified by the link stored in the game object link field 394 of the player session object 142. In response to receiving such information, the game applet 128 running on each such client directs the local client processor circuit to display the received chat message in a chat window of a displayed hand screen (not shown).

In the present embodiment, following execution of blocks 674 and/or 676, block 678 directs the processor circuit to determine whether signals representing a request to leave the current room have been received from the user to whom the player session object 142 corresponds. If so, block 680 directs the processor circuit to address the player session object 142, as well as the game object 150 identified by the game object link field 394 of the player session object, and to invoke the user session object and player session object clean-up functions, as described in greater detail above in connection with block 592 of the game server routine 123 shown in FIG. 20, to effectively cause the player to leave the room, resulting in the effective deletion of the player session object. However, unlike block 592, block 678 does not direct the processor circuit to delete the user session object 140 or enter an end time in the session log record 510, and thus, although the player is effectively removed from the room following execution of block 678, the player remains logged on to the game server 54.

In this embodiment, the player session object options routine 143 additionally includes further blocks of codes shown generally at 685, for directing the processor circuit 52 to respond to various game decisions made by players, which in this embodiment include “ante/sit out” decisions at the beginning of a hand and “in/fold” decisions at the end of a hand. In this regard, the player session object options routine 143 cooperates with the game object game routine 156 (discussed in greater detail below) to process such user game decisions to allow a hand of a game to be played.

In this embodiment, when a user is prompted to decide whether to “ante” for a given hand or to “sit out” for the round (such prompting is performed by the processor circuit 52 under the direction of block 876 of the game object game routine 156 shown in FIG. 24, discussed below), a group of blocks of codes shown generally at 695 directs the processor circuit 52 to respond to any ante/sit out decision received from the user to whom the player session object corresponds. As these functions relate closely to the play of a hand of a game, the group 695 of blocks of codes is discussed in greater detail below in connection with FIG. 24, following block 876 of the game object game routine 156.

Similarly, when players of a hand are prompted to decide whether to remain “in” or to “fold” (such prompting is performed by the processor circuit 52 under the direction of block 906 of the game object game routine 156 shown in FIG. 24), a group of blocks of codes shown generally at 725 directs the processor circuit to respond to any in/fold decision received from the user to whom the player session object corresponds. Once again, as these functions relate closely to the play of a hand of a game, the group 725 of blocks of codes is discussed in greater detail below, following block 906 of the game object game routine 156.

Following execution of the game decision blocks of codes 695 and 725, the processor circuit 52 is directed back to block 670 to continue processing as described above.

Wait Watcher Routine

Referring to FIGS. 2, 3, 6, 11, 12, 13, 14 and 23, the wait watcher routine is shown generally at 129 in FIG. 23. Generally, the wait watcher routine configures the processor circuit 52 to periodically review the waiters list 164 of players who are waiting for a vacant seat to play a specified game or type of game, and to offer to seat such players if such a seat has become available.

The wait watcher routine 129 begins with a first block 750 of codes which directs the processor circuit 52 to address the waiter object 170 in the RAM 88 who has been waiting longest to play a game, as identified by the contents of the first (oldest) entry in the waiters list 164. The creation of such waiter objects 170 is discussed in greater detail above in connection with block 584 of the game server routine 123.

Block 752 then directs the processor circuit 52 to call a “qualify” function of the logic of the addressed waiter object 170, to determine whether a seat is available matching the criteria specified in the addressed waiter object. The qualify function directs the processor circuit 52 to first examine the contents of the game ID field 475 of the waiter object 170. If the game ID field 475 contents are not equal to −1, indicating that the user has requested a specific game rather than a general game configuration, then the qualify function directs the processor circuit to locate a game object 150 in the RAM 88 whose game ID field 424 contents match those of the game ID field 475, identifying the specific game requested by the user. Upon locating such a game object, the qualify function directs the processor circuit to determine whether a free seat is available at that game, by determining whether, for any particular seat number of the game object, the corresponding sub-field of the seated field 432 and the corresponding sub-field of the reserved field 436 are both undefined, indicating that the corresponding seat number is both unoccupied and unreserved. (Alternatively, a game object including such an unoccupied and unreserved seat may be identified by subtracting a sum of the number of entries in the seated and reserved fields 432 and 436, from the contents of the maximum number of players field 454 of the game object. If the resulting difference is greater than or equal to one, then there is at least one such unoccupied unreserved seat available). Upon locating such an unoccupied, unreserved seat, block 756 then directs the processor circuit to reserve the seat for the player and prompt the player to accept it, as discussed in greater detail below. Conversely, if there is no seat available for the user, blocks 762 and 764 then direct the processor circuit to attempt to find a seat for the next waiting player identified in the waiters list, as discussed below.

However, if at block 752 the game ID field 475 contents of the currently addressed waiter object 170 are equal to −1, indicating that the user has chosen to wait for any game of a general configuration rather than a specific game or room, then the qualify function further directs the processor circuit 52 to search the game objects 150 in the RAM 88 for a game object whose configuration ID field 422, game type field 420 and number of cards field 456 match the corresponding contents of the similarly-named fields 476, 477 and 478 of the waiter object 170. In addition, if the minimum number of players field 479 of the waiter object stores a value representing a user-specified minimum number of players that the user wishes to play against, then the qualify function further directs the processor circuit to determine whether the contents of the seated field 432 of any such located game object are at least as great as the contents of the minimum number of players field 479 of the waiter object. Upon locating a game object 150 satisfying the above conjunctive conditions, the qualify function directs the processor circuit to determine whether a free seat is available at that game, by determining whether, for any particular seat number of the game object, the corresponding sub-field of the seated field 432 and the corresponding sub-field of the reserved field 436 are both undefined, indicating that the corresponding seat number is both unoccupied and unreserved (or by other methods, such as the alternative subtraction method described above for example). If the addressed game object has a free seat for the user, the processor circuit is directed to block 756 to reserve the seat for the user, as discussed below. Alternatively, if no game object 150 satisfying all of the above conditions is located, blocks 762 and 764 direct the processor circuit to attempt to find a seat for the next waiting player identified in the waiters list, as discussed below.

Upon locating a game object satisfying the user-specified criteria at block 754, block 756 directs the processor circuit 52 to reserve a seat for the user identified in the waiter object 170, and to prompt the user to accept the reserved seat. To reserve a seat at the table for the user, block 756 directs the processor circuit to copy the unique user ID stored in the user ID field 473 of the waiter object 170, to the reserved field 436 of the located game object 150. More particularly, this user ID is stored in the sub-field of the reserved field 436 corresponding to the particular located unoccupied, unreserved seat, which thereby becomes a reserved seat. As a seat has been located and reserved for the user, block 756 directs the processor circuit to effectively remove the user from the waiting list, by deleting the pointer to the waiter object 170 stored in the waiters list 164. Block 756 then directs the processor circuit to transmit prompt signals representing a prompt to the client 66 corresponding to the user, to cause the lobby applet 127 executing on the local client processor circuit of the user to prompt the user to accept or decline the reserved seat. In this embodiment, such prompt signals include identifications of the located game object 150 and of the seat number of the seat that has been reserved for the user.

In response to receiving such prompt signals, the lobby applet 127 directs the local client processor circuit of the client to display a notification to the user that a seat has been reserved, prompting the user to “accept” or “decline” the reserved seat. The lobby applet further directs the local client processor circuit to display a countdown timer, to count down a pre-determined decision time (in this embodiment, one minute) for the user to decide whether to “accept” or “decline” the reserved seat. If the user accepts the reserved seat within the allotted time, the lobby applet directs the local client processor circuit to transmit a “sit” request to the game server 54 via the network 64, including an identification of the located game object 150 and the reserved seat number. This “sit” request is then received and processed by the processor circuit 52 under the direction of blocks 640 through 644 of the user session object options routine 141 shown in FIG. 21, as discussed above. If the user does not respond within the allotted time or declines, the lobby applet directs the local client processor circuit to cease displaying the prompt and the user is no longer able to accept or decline the reserved seat.

In addition, in this embodiment, concurrently with transmitting the prompt signals to the user, block 756 directs the processor circuit 52 to commence execution of a separate “unreserve thread” (not shown). The unreserve thread directs the processor circuit to commence a countdown of a time equal to the decision time provided to the user to accept or decline the reserved seat (in this embodiment, one minute). At the expiry of the decision time, the unreserve thread directs the processor circuit to determine whether the sub-field of the reserved field 436 corresponding to the seat that was reserved for the user at block 756 still contains the user's user ID, and if so, to delete it from the sub-field. Thus, if the user fails to respond, the reserved seat is effectively unreserved. (Conversely, if the user does respond within the allotted time, the processor circuit 52 will have already seated the user and removed the user's user ID from the reserved field 436, under the direction of block 644 of the user session object options routine 141 shown in FIG. 21, as discussed above).

In this embodiment, immediately following the transmission of the prompt signals to the user and the commencement of the execution of the unreserve thread at block 756, block 762 directs the processor circuit 52 to determine whether the waiters list 164 includes identifications of any further waiter objects 170. If so, block 764 directs the processor circuit to address the waiter object 170 corresponding to the user who has been waiting for a seat for the next-longest amount of time, as identified by the contents of the next successive entry in the waiters list 164. The processor circuit is then directed back to block 752, to call the qualify function of the newly-addressed waiter object, to attempt to find a matching game, as described above.

If at block 762, there are no more waiters identified in the waiters list 164, block 766 directs the processor circuit to wait until a pre-defined interval, which in this embodiment is five seconds, has elapsed, and to then return to block 750 to once again sequentially address the waiter objects identified by the waiters list 164, to determine whether any seats have become available for any of the waiters.

Additionally, if desired, the wait watcher routine may include further blocks of codes (not shown) for directing the processor circuit 52 to monitor the contents of all game ID fields 475 and all configuration ID fields 476 of all waiter objects 170, to maintain a “lineup” value for each game available on the game server, representing the number of players who are presently waiting to play either the specific game or a game configuration matching the specific game. Such a lineup value may be displayed in the lobby screen, for example, so that a user will know how many other players are already waiting to play a given game before deciding whether to request to be placed on a waiting list. It will be appreciated that each such lineup value need only be updated when a waiter object is created or deleted from the waiters list.

Game Object Game Routine

Referring to FIGS. 2, 3, 4, 5, 6, 8, 9, 11, 12, 13, 22 and 24 (consisting of FIGS. 24A and 24B), the game object game routine is shown generally at 156 in FIG. 24. Generally, the game object game routine 156 directs the processor circuit to automatically determine, in response to the performance indicator 56 indicative of performance of a player in one hand of a game, an ante amount for the player for a subsequent hand of the game. More particularly, in the present embodiment there are a plurality of players, and accordingly, the game object game routine configures the processor circuit to automatically determine, in response to a plurality of performance indicators indicative of performance of a plurality of respective players in one hand of a game, an ante amount for each of the players for a subsequent hand of the game.

More particularly still, in the present embodiment, the performance indicator 56 for each player includes the contents of the next ante field 414, the ante flag field 410, the in flag 408 and the hand object 144 of the player's player session object 142. The processor circuit is configured to generate and store the performance indicator in the second memory device 84, as discussed in greater detail below. When configured in this manner, therefore, the processor circuit effectively acts as a means for associating with a player, a performance indicator indicative of performance of the player in one hand of a game, and acts as a means for automatically determining an ante amount for the player for a subsequent hand of the game, in response to the indicator.

To achieve the foregoing in the present embodiment, the game object game routine directs the processor circuit to implement a modified on-line game of guts poker, as described in greater detail below.

Effectively, in the present embodiment, for a first hand of guts poker, each player sequentially decides whether to ante in (by contributing a default ante amount to the pot) or to sit out. Each player who chooses to sit out is then precluded from playing for the rest of the current round, as that player has chosen not to contribute to the growing pot for the round. Each player who antes is then dealt a number of cards, which in this embodiment is two cards. Each player sees his or her own cards, but not the cards of the other players. All players then decide whether to remain “in” or to “fold”, but unlike the ante/sit out stage, the “in” or “fold” decisions of all players are announced to all players simultaneously, rather than sequentially. The player who stays “in” and wins, wins the pot, which for the first hand is simply the sum of the antes. The winning player will then be permitted to decide whether he or she wishes to ante in to play the next hand, and if so, he or she will merely have to contribute the default ante. Likewise, any player who anted in but then folded at the “in/fold” stage will also be permitted to decide whether he or she wishes to ante in to play the next hand, and if so, he or she will also merely have to contribute the default ante. However, any player who stayed “in” and lost, is automatically forced to contribute a much larger ante for the next hand, which in this embodiment is equal to the amount of the pot that was won. Similarly, for the second hand, each player who stays “in” and loses will have to automatically contribute an ante amount for the third hand, equal to the pot of the second hand. Accordingly, the size of the pot can grow considerably through the course of a round. For that reason, new players are not permitted to join in during the course of a round, to prevent such new players from taking advantage of large pots comprising antes contributed by those who have already lost hands of the round, without such new players having incurred any risk or having contributed to the pot size. A round is defined as commencing on the first hand, and will continue to remain in progress through a number of hands, until a hand occurs in which there is at least one winner and there are no players who stay “in” and lose, at which point the round ends. In that case, the pot for the following hand would merely be the sum of the default ante amounts for all players in any event, so permitting new players to join in at that point does not permit such new players to take advantage of large pots contributed by others during previous hands with no risk to themselves.

In this embodiment, the RAM 88 effectively acts as a computer-readable medium storing codes for directing the processor circuit 52 to automatically determine, in response to a performance indicator indicative of performance of a player in one hand of a game, an ante amount for the player for a subsequent hand of the game. By executing the game object game routine 156, the game server 54 effectively produces a signal including a code segment for directing the processor circuit 52 to automatically determine, in response to a performance indicator indicative of performance of a player in one hand of a game, an ante amount for the player for a subsequent hand of the game. Alternatively, however, other computer-readable media, or other types of signals or methods of their generation, may be substituted if desired.

The game object game routine begins with a first block 850 of codes, which directs the processor circuit 52 to initialize the player session objects 142 of all players seated at the table, to commence a new round of the game. More particularly, in this embodiment block 850 directs the processor circuit to use the links to such player session objects stored in the seated field 432 of the game object 150 to address these player session objects, to set the contents of the next ante fields 414 of all such player session objects equal to the default ante amount stored in the default ante field 458 of the game object, and to set the contents of the ante flag fields 410 equal to zero (false).

In addition, in this embodiment the game object game routine 156 configures the processor circuit 52 to maintain a round indicator indicative of whether a round of the game is in progress. More particularly, in this embodiment the round indicator includes the round-in-progress flag field 448 of the game object 150. Block 850 directs the processor circuit to set the round-in-progress flag stored in the round-in-progress flag field equal to zero initially, to indicate that a round is not yet in progress.

In the present embodiment, block 850 directs the processor circuit 52 to copy the next available hand number global value from the global values table 160 to the hand number field 426 of the game object 150, and to increment the next available hand number global value in the global values table.

Block 852 then directs the processor circuit 52 to clear the contents of the cards fields 402 of all hand objects 144 of all player session objects identified by their links in the seated field 432 of the game object 150. Block 852 also directs the processor circuit to set the hand flag stored in the hand-in-progress flag field 446 false (if it is not already false) to indicate that a hand is not yet in progress.

In addition, block 852 also directs the processor circuit to transmit GAME INIT information to the clients 66 corresponding to not only the player session objects identified by the seated field, but also to the player session objects identified by links in the watching field 434 as well, to cause such clients to generate a display of a game table corresponding to the game object 150. More generally, at each step of the game object game routine 156 for a given game object 150, the processor circuit 52 will be directed to transmit such game init information to all players and watchers representing a screen display of the table as it appears to a non-seated watcher at the table. Accordingly, for conciseness, an express description of such transmissions of game init information will be omitted in most of the remainder of this specification.

In addition, in this embodiment block 852 directs the processor circuit 52 to set the contents of the state field 468 equal to one, to indicate a first state of the game in which the server is waiting to determine if enough eligible players are seated.

Block 854 then directs the processor circuit 52 to determine whether the number of seated players who are eligible to play a hand is at least as great as the minimum number of players to play a hand of the game. In this regard, it will be recalled from the discussion of blocks 810 to 814 above that if a player becomes seated at a table while a round is in progress, that player will not normally be permitted to play a hand until the current round ends and a new round begins. Accordingly, block 854 directs the processor circuit to first determine the number of seated players, which is equal to the number of links in the seated field 432. Block 854 then directs the processor circuit to determine the number of ineligible seated players, which is equal to the number of seated players whose player session objects 142 include both a) next ante field 414 contents equal to −1, and b) ante flag field 410 contents equal to 0. Block 854 directs the processor circuit to subtract the number of ineligible seated players from the number of seated players to determine the number of eligible seated players, and to compare that number to the contents of the minimum number of players field 452.

If the number of seated eligible players is less than the minimum number of players, then block 856 directs the processor circuit 52 to determine whether a round is in progress, by examining the contents of the round-in-progress flag field 448. If so, then it logically follows (from the facts that there are not enough seated eligible players, and that any new players who now become seated while a round is in progress will not be eligible to play during the round) that it will not be possible to play a hand of the game until the next round begins. This situation may occur, for example, if one or more players decline to ante during the round, or do not have sufficient funds to cover their potential required antes for the subsequent hand of the round, thereby rendering themselves ineligible to continue for the remainder of the round, as discussed in greater detail below in connection with blocks 886 to 888 of the player session object options routine 143 and block 866 and 868 of the game object game routine 156, respectively. Similarly, this situation may arise if one or more players leave the table during the middle of the round, causing the number of seated players to drop below the minimum number, and such players are replaced by newly-seated players who will not be eligible to play until the next round.

If a round is in progress at block 856 indicating that no further hands of the current round will be possible, block 858 directs the processor circuit 52 to distribute any pot amount presently existing, and to then commence a new round of the game. With respect to the pot, it will be appreciated that if there were no winners of the previous hand played (for example, if everyone folded), then the pot field 472 will still contain the antes of the players from the previous hand. Similarly, if there was at least one loser and at least one winner in the previous hand, then the pot field 472 will contain the automatically debited antes for the current hand of any losers of the previous hand, as discussed in greater detail below in connection with block 950. Accordingly, in this embodiment, rather than leave the pot available for new players joining in the new round, who did not contribute to the pot, if the pot field 472 contents are non-zero, block 858 directs the processor circuit to distribute such contents to one or more “stalemate winners”, according to predefined stalemate distribution rules. More particularly, in this embodiment, if at block 854 it was determined that there is only one seated eligible player, block 858 directs the processor circuit to identify that player as the stalemate winner, and to give the pot to that player. Alternatively, if at block 854 it was determined that there are no seated eligible players, block 858 directs the processor circuit to identify, as the stalemate winner, the player(s) who won the most recently won hand at the table. Referring back to FIG. 8, this most recent winner may be identified by locating the hand summary record 320 whose game ID field 324 contents match those of the game ID field 424 of the game object, whose winners field 336 contains at least one identification of a winner, and whose end time field 328 indicates the most recent end time of any such records corresponding to the present game and having at least one winner. Alternatively, in this embodiment, if at block 854 it was determined that there are more than one seated eligible players, but still not enough to play a hand, then block 858 also directs the processor circuit to identify, as the stalemate winner, the player(s) who won the most recently won hand at the table, as discussed immediately above. In this embodiment, once one or more stalemate winners are identified according to the above stalemate distribution rules, the particular functions which block 858 directs the processor circuit to execute in order to distribute the pot among such stalemate winners, are the same as those described in greater detail below in connection with block 930, in the context of the winning of a hand, and therefore, a detailed description of such functions is not duplicated herein in connection with block 858.

Following execution of block 858, the processor circuit 52 is directed to block 946 (discussed below) to notify the players that a new round is commencing, and is then directed back to block 850 as described above, to commence a new round of the game.

However, if at block 856, a round is not in progress, then it follows (from the fact that seated players may only be rendered ineligible after the round-in-progress flag has been set active at block 860 below) that all players presently seated at the table are eligible to play the next hand, as are all players who may become seated at the table before the next hand commences. In this case, therefore, the processor circuit 52 is directed back to block 854 to continue waiting until the number of seated eligible players is at least the minimum number of players for the game.

If there are at least the minimum number of eligible players at block 854, block 860 directs the processor circuit to transmit an announcement of a new hand to all players identified in the player lists 430 of the game object 150, and to wait for a delay period identified by the contents of the hand delay field 464 of the timing parameters field 460 of the game object. At this time, block 860 also directs the processor circuit to set the contents of the state field 468 equal to 2, to indicate a delay state of the game. Block 860 further directs the processor circuit to set the contents of all decided flag fields 406 of all player session objects 142 identified by links in the seated field 432 inactive, for the purpose of awaiting decisions from seated eligible players. Additionally, in this embodiment, as there are sufficient eligible players to proceed, a round is now deemed to be in progress. Accordingly, block 860 directs the processor circuit to set the round indicator active at a commencement of a first state of the game. More particularly, in this embodiment the first state is the confirmation at block 854 that there are sufficient eligible players for a hand to proceed, and thus, if the contents of the round-in-progress flag field 448 are not already active, block 860 directs the processor circuit to set such contents active.

Blocks 862 through 902 then direct the processor circuit 52 to obtain antes from the various players seated at the table, in the following manner.

In this embodiment, block 862 first directs the processor circuit 52 to set the contents of the state field 468 equal to 3, to indicate anteing in progress. Block 862 then directs the processor circuit 52 to address the first seated player. In this regard, block 862 directs the processor circuit to address the player session object 142 whose seat number field 412 contents are equal to the contents of the current position field 438 of the game object.

Block 864 then directs the processor circuit to determine whether the addressed player session object 142 is that of a player who was “in” and lost in the preceding hand, by determining whether both a) the next ante field 414 contents are equal to −1, and b) the ante flag field 410 contents are equal to 1. If so, then that player has already been forced to automatically ante for the present hand, at the end of the previous hand. Therefore, in the present embodiment it is not necessary or appropriate to prompt such a player to contribute a further ante for the present hand. At the same time, however, it is necessary to ensure that the player will have sufficient funds to cover his or her loss if he does stay “in” in the present hand.

Accordingly, if the addressed player is identified at block 864 as a loser of the previous hand, blocks 866 and 868 configure the processor circuit 52 to permit the addressed player to play the one hand (i.e. the present hand) only if the player has available funds of at least a maximum possible value of the ante amount for the subsequent hand (which in this embodiment is the next successive hand). To achieve this, block 866 directs the processor circuit to calculate the maximum possible value of the ante amount for the subsequent hand. To achieve this, block 866 directs the processor circuit to read the current contents of the pot field 472 (which already include ante amounts for the present hand contributed automatically by losers of the previous hand). Block 866 further directs the processor circuit to calculate the maximum possible additional amount that can be contributed to the pot during the present hand. To achieve this, block 866 directs the processor circuit to identify the number of winners and folders from the previous hand, or more particularly, the number of player session objects 142 listed in the seated field 432, having next ante field 414 contents equal to those of the default ante field 458. Block 866 directs the processor circuit to multiply this number by the contents of the default ante field 458 to determine the maximum additional ante amount, and adds this maximum additional ante amount to the contents of the pot field 472 to determine the maximum possible pot for the present hand, which is equal to the maximum possible mandatory automatic ante amount for the next hand to be contributed by any given player if that player loses the present hand.

Block 866 then directs the processor circuit 52 to compare the maximum possible value to account record contents indicative of the available funds of the player, or more particularly, to the contents of the game balance field 248 of the user game record 240 shown in FIG. 5 corresponding to the currently addressed player and game. If the maximum possible pot, or maximum possible ante amount for the next hand, is greater than the contents of the game balance field 248, then block 868 directs the processor circuit 52 to notify the currently addressed player of his or her insufficient funds, to notify other players that the currently addressed player is “out”, and to render the currently addressed player ineligible to play the present hand. In this embodiment, such ineligibility is achieved by setting the ante flag field 410 contents of the currently addressed player session object 142 false, and by setting the next ante field 414 contents equal to the default ante amount stored in the default ante field 458. Thus, the currently addressed player (who has already been automatically forced to ante for the present hand) will be ineligible to play the present hand, but for the purpose of anteing for the next hand, the player will be treated as if he or she were a winner or folder of the present hand, and will be permitted to decide whether or not to ante in for the next hand after the present one.

Block 868 further directs the processor circuit 52 to generate a hand details record 350 in the hand details table 112, with the contents of the hand number field 352, game ID field 354, and user ID field 358 contents being copied from the hand number field 426, the game ID field 424 and the user ID field 380 respectively. Block 868 directs the processor circuit to store the current time and date in the transaction time field 356, and to store a value in the transaction type field 360 indicating a forced sit-out due to insufficient funds. The remaining fields of the hand details record 350 are left undefined. Block 868 further directs the processor circuit 52 to set the contents of the decided flag field 406 of the currently addressed player session object 142 active, to indicate that a decision from the addressed player is not being awaited.

Alternatively, if at block 864 it was determined that the currently addressed player session object 142 does not correspond to a loser from the preceding hand, block 872 directs the processor circuit 52 to determine whether it instead corresponds to a player who is barred from playing the remainder of the round that is currently in progress, and will not be permitted to play a hand until the next round commences. In this embodiment, such barred players include players who have not contributed to the growth of the pot of the present hand. More particularly, in this embodiment, barred players include mid-round joiners (or in other words, players who first sat down at the table while the present round was already in progress), as well as players who chose to “sit out” rather than ante for a given hand. To identify such barred players in the present embodiment, block 872 directs the processor circuit to determine whether both a) the next ante field 414 contents are equal to −1, and b) the ante flag field 410 contents are equal to zero, and if so, block 873 directs the processor circuit transmit a notification to all clients of all players, to indicate that the player corresponding to the currently addressed player session object 142 is not permitted to play a hand until the current round ends and the next round begins. Block 873 then directs the processor circuit to set the decided flag field 406 contents of the currently addressed player session object true, to indicate that a decision is not being awaited from the player.

If, at block 872, it was determined that the currently addressed player session object 142 does not correspond to a mid-round joiner, then logically, the player session object must correspond to either a winner or a folder from the previous hand (whose next ante field 414 contents are equal to the default ante amount, and whose ante flag field 410 contents are false).

Therefore, as winners and folders from the previous hand are permitted to decide whether or not to ante, in this embodiment block 874 directs the processor circuit 52 to first determine whether the addressed player has sufficient funds to cover his or her possible losses for the present hand, and provide the user does have sufficient funds, the user will be prompted to ante or sit out at block 876.

More particularly, block 874 directs the processor circuit 52 to determine whether or not the player has sufficient funds to cover the maximum possible loss, or in other words, the maximum possible pot of the present hand, which will be equal to the maximum possible ante for the next hand of any player who loses the present hand. This determination is identical to that described above in connection with block 866 above.

If at block 874 the player does not have sufficient funds, block 875 directs the processor circuit 52 to notify the addressed player of the insufficient funds, and to generate a hand details record 350 with transaction type field 360 contents indicating an involuntary sit-out due to insufficient funds, in a manner similar to that described above in connection with block 868. Block 888 then directs the processor circuit to set both a) the next ante field 414 contents equal to −1, and b) the ante flag field 410 contents false, to render the player ineligible to play the present hand and the remainder of the present round, and further directs the processor circuit to transmit a notification to all other players that the currently addressed player is “out”. Block 875 further directs the processor circuit to set the decided flag field 406 contents true.

Conversely, if at block 874 the player does have sufficient funds to cover the maximum possible loss for the hand, block 876 directs the processor circuit 52 to transmit signals to the client 66 corresponding to the currently addressed player session object 142, to cause the client to display a prompt, requesting the player to ante or sit out. In response to the prompt signals, the game applet 128 executing on the local client processor circuit of the client 66 directs the local client processor circuit to await either receipt of user input representing an “ante” or a “sit out” decision. In response to either of these two events, the game applet 128 directs the local client processor circuit to transmit corresponding game decision signals to the game server 54 via the network 64, for response by the processor circuit 52 under the direction of the player session object options routine 143. Thus, following execution of block 876, block 894 of the game object game routine directs the processor circuit to monitor the contents of the decided flag field 406 of the player session object 142 of the player who was prompted to ante at block 876, to determine whether the decided flag has been set active by the processor circuit 52 under the direction of the group 695 of codes of the player session object options routine 143 shown in FIG. 22, including blocks 878 through 893. As noted, as blocks 878 through 893 of the player session object options routine relate directly to game decisions, they are discussed in the context of the game object game routine.

Block 878 of the player session object options routine 143 corresponding to the presently addressed player directs the processor circuit 52 to determine whether signals representing an “ante” selection have been received from the player, and if so, block 882 directs the processor circuit to set the contents of the ante flag field 410 of the currently addressed player session object 142 true, and to notify all seated and watching players that the currently addressed player has anted, such notification in the present embodiment including game init information to cause a display on each client 66 to show an ante being thrown into the pot by the currently addressed player. Block 893 then directs the processor circuit to set the contents of the decided flag field 406 true to indicate that a decision is no longer being awaited.

Similarly, block 886 of the player session object options routine 143 of the addressed player session object 142 directs the processor circuit 52 to determine whether signals representing a “sit out” decision have been received from the player, and if so, block 887 directs the processor circuit to generate a new hand details record 350 in a manner similar to that described above in connection with block 868, having transaction type field 360 contents indicative of a voluntary decline to ante. The processor circuit is then directed to blocks 888 and 893 to render the player ineligible to play the present hand and the remainder of the present round. To achieve this, block 888 directs the processor circuit to set both a) the next ante field 414 contents equal to −1, and b) the ante flag field 410 contents false, to render the player ineligible to play the present hand and the remainder of the present round, and further directs the processor circuit to transmit a notification to all other players that the currently addressed player is “out”. Block 893 then directs the processor circuit to set the decided flag field 406 contents true.

Thus, block 894 of the game object game routine 156 configures the processor circuit 52 to monitor the decided flag field 406 contents of the player session object 142 of the player who was prompted at block 876, to determine whether the decided flag has been set active at block 893 of the player session object options routine 143, indicating a voluntary choice by the player to either “ante” or “sit out”.

At the same time, in this embodiment, block 894 directs the processor circuit 52 to monitor the time that has elapsed since the player was prompted to ante at block 876. If the decided flag field 406 contents have still not been set active after half of maximum permitted decision time, as represented by the contents of the decision time field 462 of the game object 150, then block 894 directs the processor circuit 52 to transmit signals to the user's client via the network 64, to notify the user that half of the maximum permitted decision time has already elapsed. If the decided flag field 406 contents have still not been set active when the entire time indicated in the decision time field 462 has elapsed following the prompt at block 876, then block 894 directs the processor circuit 52 to transmit a timeout notification to the client 66 of the currently addressed player, and to generate a hand details record 350 in a manner similar that described above in connection with block 868, having transaction type field 360 contents indicative of a timeout failure to ante. Block 894 then directs the processor circuit to set the next ante field 414 contents equal to −1 and the ante flag field 410 contents false, thereby rendering the addressed player ineligible to play the present hand and the remainder of the present round. Block 894 further directs the processor circuit to set the contents of the decided flag field 406 active, and the processor circuit is directed to block 895.

In this embodiment, block 895 directs the processor circuit 52 to determine whether all players have provided any necessary ante decisions. To achieve this, block 895 directs the processor circuit to determine whether the decided flag field 406 contents of all player session objects 142 identified by links in the seated field 432 are true (having been set true at either block 893 of the player session object options routine 143 in the case of a player who voluntarily antes or sits out, at block 894 of the game object game routine in the case of a player who times out, blocks 868 or 875 in the case of players who lack sufficient funds to proceed, or block 873 in the case of players who joined in the middle of a round, as discussed above). If they are not all true, block 896 directs the processor circuit to address the next seat position at the table, by incrementing (and resetting, if necessary) the contents of the current position field 438 and previous position field 440 of the game object 150, so that the previous position field 440 contains a value representing the seat number field 412 contents of the preceding addressed player session object addressed above, and the current position field 438 contains a value representing the next clockwise seat number at the table. Block 896 directs the processor circuit to address the player session object 142 having seat number field 412 contents equal to the current position field 438, and to determine whether both a) the contents of the decided flag field 406 are inactive, and b) the player session object is listed in the seated field 432. If so, the processor circuit is directed to address that player session object 142, and is directed back to blocks 864 through 895 as described above, to extract any necessary anteing decisions from the player to whom the player session object corresponds. If the addressed player session object does not correspond to a seated undecided player, block 896 directs the processor circuit to continue updating the current and previous position fields, and to continue addressing successive player session objects corresponding to the next clockwise seat at the table, until an undecided seated player is effectively located, in which case the corresponding player session object is similarly subjected to processing at blocks 864 through 895 as described above.

Once it is determined at block 895 that the decided flag field 406 contents are true for all decided players, block 898 directs the processor circuit 52 to determine whether the number of players who have anted is at least as great as the minimum number of players required to play the game. To achieve this, block 898 directs the processor circuit to compare the number of player session objects 142 identified in the seated field 432 whose ante flag field 410 contents are true, to the contents of the minimum number of players field 452.

If at block 898 the number of anted players is less than the minimum number of players, block 900 directs the processor circuit to transmit a notification to that effect to all players. In this case, it is noted that although ante flags have been set true for those who have voluntarily anted, at this point the ante amounts have not yet been subtracted. Accordingly, in the case of any players who were winners or folders in the preceding completed hand, in order to effectively re-start the hand it is only necessary to reset the contents of the ante flag fields 410 of such winners or folders, to allow them to once again decide whether they wish to ante or fold from the hand. However, in the case of losers of the preceding hand, such losers have already been forced to contribute their antes for the present hand, and therefore it is desirable to leave their ante flag contents set true, so that they do not have to ante a second time. Thus, to achieve these effects, block 900 directs the processor circuit to identify any player session objects 142 identified in the seated field 432 having next ante field contents equal to the default ante stored in the default ante field 458, and to reset the ante flag field 410 contents of any such identified records to false. The processor circuit is then directed back to block 852, to commence a new hand.

If, on the other hand, it is determined at block 898 that the number of players who anted is at least the minimum number of players for the game, block 902 directs the processor circuit 52 to receive the default ante amounts from any winners or folders of the previous hand. To achieve this, block 902 directs the processor circuit to identify any player session objects 142 listed in the seated field 432 that have both a) next ante field 414 contents equal to the default ante value in the default ante field 458, and b) ante flag field 410 contents equal to one (true). For each such identified player session object 142, block 902 directs the processor circuit to first set the contents of the hand start balance field 250 of the user game record 240 corresponding to the player session object, equal to the contents of the game balance field 248. Block 902 then directs the processor circuit to subtract the contents of the next ante field 414 from the game balance field 248, and to add such contents to the pot field 472. For each such ante, block 902 further directs the processor circuit to generate a hand details record 350 in the hand details table 112, in a manner somewhat similar to that described above in connection with block 868, with transaction type field 360 contents indicating a voluntary ante, and transaction amount field 362 contents indicating the amount of the ante.

At this point, it is now certain (apart from the possibility of a server failure) that the hand will be completed, and therefore, block 902 directs the processor circuit 52 to set the contents of the hand-in-progress flag field 446 active, and also directs the processor circuit to increment the contents of the total number of hands field 274 of the games record 260 corresponding to the game object 150, and to increment the contents of the total number of hands fields 218 of all user records 200 in the user table 102 corresponding to player session objects 142 having true ante flag field 410 contents indicating that they are playing the hand.

In addition, in this embodiment block 902 directs the processor circuit 52 to generate a new hand summary record 320 in the hand summary table 110 shown in FIG. 8, and to copy the contents of the hand number field 426 and the game ID field 424 to the corresponding fields 322 and 324 of the hand summary record. Block 902 further directs the processor circuit to store a value representing the current time and date in the start time field 326, and to store the number of anted players in the number of players field 330.

Block 904 then directs the processor circuit 52 to shuffle the deck, as described above in connection with the logic of the deck object 442, and to deal a number of cards indicated in the number of cards field 456 to each player whose player session object 142 is listed in the seated field 432 and whose ante flag field 410 contents are true, one card at a time. In this embodiment, the number of cards is two, however, other numbers of cards may be readily substituted, such as 3, 5 or 7 cards, for example. To deal the cards, block 904 directs the processor circuit to cut the contents of the first available card field in the shuffled deck object 442, and to paste the value representing the first available card into the cards field 402 of the hand object 144 of the player session object 142 corresponding to the player who is to receive the first card (determined by seat number field 412 contents going clockwise), and so on.

As the cards are dealt, in this embodiment block 904 directs the processor circuit 52 to set the contents of the state field 468 equal to 5, to indicate a dealing cards state of the game (in the present embodiment, state value 4 is not used). Block 904 also directs the processor circuit to transmit game init information to each of the clients 66 corresponding to all player session objects 142 listed in the seated field 432 and the watching field 434, for use by the clients 66 in generating “face-down” displays of the cards as they are dealt. In addition, however, for each player listed in the seated field 432 whose ante flag is true, block 902 further directs the processor circuit to transmit game init information representing an encrypted card request button for actuation by the player at the client. In response to actuation by the user of the encrypted card request button, the client transmits a request signal to the processor circuit 52, in response to which the processor circuit transmits encrypted signals representing only those cards that have been dealt to the particular player corresponding to the client. Thus, each player receives unencrypted signals representing “face down” images of the other players' cards, but receives encrypted signals representing “face up” images of the player's own cards, for added security.

In addition, as cards are dealt to each player, block 904 further directs the processor circuit 52 to generate a new hand details record 350, in a manner similar that described above in connection with block 868. In this case, however, the transaction type field 360 contents are set equal to a value representing dealt cards, and the cards field 364 contents are set equal to values representing the cards the player received. In addition, the privacy flag field 368 contents are set active, so that only the player who received the cards (or the proprietor of the game server) will be able to subsequently review the hand details record to identify what cards the player had at that point in time; the player's competitors will not be able to subsequently view this information.

Block 906 then directs the processor circuit 52 to prompt all players who have anted to decide whether they will stay “in” or “fold”. It will be recalled that in the present embodiment, if a player folds or wins in the present hand, his or her ante for the next hand is equal to the default ante amount, but if the player remains “in” and loses the present hand, that player's ante for the next hand is equal to the pot of the present hand, and is automatically debited. Thus, block 906 directs the processor circuit to simultaneously transmit signals to the clients corresponding to all player session objects 142 listed in the seated field 432 whose ante flag field 410 contents are true, such signals representing a simultaneous prompt for all players to respond with their “in” or “fold” decisions, which in the present embodiment are announced simultaneously to all players. Block 906 directs the processor circuit to set all decided flag field 406 contents equal to zero (false).

In response to the prompt signals, the game applet 128 executing on the local client processor circuit of the client 66 directs the local client processor circuit to await either receipt of user input representing an “in” or a “fold” decision. In response to either of these two events, the game applet 128 directs the local client processor circuit to transmit corresponding game decision signals to the game server 54 via the network 64, for response by the processor circuit 52 under the direction of the player session object options routine. To achieve this, in the present embodiment, immediately following the prompt at block 906, block 919 directs the processor circuit 52 to monitor the contents of the decided flag fields 406 of all player session objects 142 of all players who were prompted to make an in/fold decision at block 906 (i.e., all player session objects 142 listed in the seated field 432 whose ante flag field 410 contents are true), to determine whether all such decided flags have been set active by the processor circuit 52 under the direction of the group 725 of codes of the player session object options routine 143, including blocks 908 through 915 shown in FIG. 22. As noted, as these blocks of the player session object options routine relate directly to game decisions, they are discussed in the context of the game object game routine. Each of the group 725 of blocks of codes of each of the player session object options routines 143 is executed in a similar fashion, and therefore, only a single such group of blocks of codes corresponding to a single exemplary player session object 142 is discussed for illustrative purposes.

In this embodiment, block 908 of the player session object options routine 143 directs the processor circuit 52 to determine whether signals representing an “in” decision have been received from the player to whom the player session object 142 corresponds, and if so, block 910 directs the processor circuit to set the contents of the in flag field 408 of the player session object equal to one (true). Block 910 also directs the processor circuit to generate a hand details record 350 in a manner similar to that described above in connection with block 868, with transaction type field 360 contents indicating a voluntary “in” decision. For this purpose, however, it is not necessary to define any cards field 364 contents indicating the cards in the cards field 402 of the hand object 144 of the player session object at that time, as such cards have already been recorded in a separate hand details record with the privacy flag set active, as discussed above in connection with block 904, and will also be recorded in a further “show” transaction hand details record, as discussed below in connection with block 920. Therefore, the cards field 364 may remain undefined, and the privacy flag field 368 contents may be set false. Block 915 then directs the processor circuit to set the decided flag field 406 contents active, to indicate to the game object that the player's decision has been made.

Similarly, block 912 of the player session object options routine 143 directs the processor circuit 52 to determine whether signals representing a “fold” decision have been received from the player to whom the player session object 142 corresponds, and if so, block 914 directs the processor circuit to address the corresponding player session object 142, and to set the contents of the in flag field 408 false, to indicate that the player has folded. Block 914 also directs the processor circuit to generate a hand details record 350 in a manner similar to that described above in connection with block 868, with transaction type field 360 contents indicating a voluntary “fold” decision, cards field 364 contents left undefined, and privacy flag field 368 contents set inactive. Block 915 then directs the processor circuit to set the decided flag field 406 contents active, to indicate to the game object that the player's decision has been made.

Thus, block 919 of the game object game routine 156 configures the processor circuit 52 to monitor the decided flag field 406 contents of the player session objects 142 of all of the players who were prompted at block 906, to determine whether all of the decided flags have been set active at block 915 of the player session object options routine 143, indicating a voluntary choice by the player to either remain “in” or to “fold”.

At the same time, in this embodiment, block 919 directs the processor circuit 52 to monitor the time that has elapsed since the players were prompted to submit their in/fold decisions at block 906. If any of the decided flag field 406 contents have still not been set active after half of maximum permitted decision time, as represented by the contents of the decision time field 462 of the game object 150, then block 919 directs the processor circuit 52 to transmit signals via the network 64 to the client corresponding to any player whose decided flag is not yet active, to notify each such user that half of the maximum permitted decision time has already elapsed.

If at block 919, any of the decided flag field 406 contents of any of the player session objects 142 of any of the prompted players have still not been set active when the entire time indicated in the decision time field 462 has elapsed following the prompt at block 906, then block 919 directs the processor circuit 52 to deem each such player to have folded. More particularly, the processor circuit sets the in flag field 408 contents of the player session object of each such player equal to zero (false) and the decided flag field 406 contents equal to one. Block 919 then directs the processor circuit to set the next ante field 414 contents equal to the default ante amount stored in the default ante field 458 of the game object 150, thereby preserving the player's potential eligibility to play the remainder of the present round. Block 919 also directs the processor circuit to generate a hand details record 350 in a manner similar to that described above in connection with block 868, with transaction type field 360 contents indicating an involuntary timeout “fold” decision, cards field 364 contents undefined, and privacy flag field 368 contents inactive. The processor circuit is then directed to block 920 below.

Otherwise, if the allotted decision time has not yet elapsed, the processor circuit 52 is directed to continue processing at block 919 until either decisions or timeout indications have occurred for all players, as described above. In this regard, as the prompts are provided at block 906 to all anted players simultaneously, it will be appreciated that in the absence of voluntary “in” or “out” decisions, the involuntary timeout “fold” decisions will be imposed on each player approximately simultaneously at block 919.

When it is determined at block 919 that in/fold decisions have been either made by or imposed on all anted players, block 920 directs the processor circuit 52 to simultaneously notify the players of in decisions and fold decisions of all of the players. In this regard, block 920 directs the processor circuit to simultaneously transmit, to all clients of all players seated at or watching the game, game init information representing the in/fold decisions of all anted players, and representing a display of the pot remaining in the center of the table, for simultaneous display at the clients 66. In this embodiment, block 920 further directs the processor circuit to generate a new hand details record 350 for each of the seated and anted players, in a manner similar to that described above in connection with block 868, having transaction type field contents representing a “show” transaction, and cards field 364 contents equal to the contents of the cards field 402 of the corresponding seated anted player. Block 920 directs the processor circuit to set the privacy flag field 368 contents inactive for any player whose in flag field 408 contents are active indicating the player stayed in, and conversely, the processor circuit sets the privacy flag field contents active for any player whose in flag field contents are inactive, indicating the player folded.

Block 921 then directs the processor circuit 52 to determine whether all players have folded. To achieve this, block 921 directs the processor circuit to address all player session objects listed in the seated field 432, whose ante flag field 410 and decided flag field 406 contents are all true. If the in flag field 408 contents of all such records are false, then all players have either voluntarily or involuntarily folded. In this case, no pot is won and no rake is taken. However, the round is not considered to be terminated, as the players of the present hand have contributed a considerable pot which is to remain available for the next hand, and it would be unfair to prevent new players who have not contributed to the accumulated pot to join in at this stage.

Thus, if at block 921 it is determined that all players have folded, block 922 directs the processor circuit 52 to notify all players associated with the game object 150 that the pot has not been won and that a new hand is about to commence. Block 922 then directs the processor circuit to update various records and fields for all of the players who folded. For each such folded player, or more particularly, for each player session object 142 in the seated field 432 having active ante flag field 410 and decided flag field 406 contents but inactive in flag field 408 contents, block 922 directs the processor circuit to store further information in the hand summary record 320 generated at block 902 above, by copying the contents of the pot field 472 to the pot field 332, and by storing the current time and date in the end time field 328. The rake field 334 and the winners field 336 are left blank. Block 922 further directs the processor circuit to update the player session object 142 of each identified folding player, by setting the next ante field 414 contents equal to those of the default ante field 458, and by setting the ante flag field 410 contents equal to false, so that each folder will be prompted to voluntarily ante for the next hand at the next execution of block 876. Block 922 also directs the processor circuit to set the contents of the in flag fields 408 of all player session objects in the seated field 432 false. The processor circuit 52 is then directed back to block 852 to commence a new hand of the current round, as described above.

If at block 921 it is determined that at least one player has not folded, block 928 directs the processor circuit 52 to identify a winner of the hand (or a plurality of winners in the case of a tie). In this regard, it will be recalled that the logic of the hand object 144 directs the processor circuit to generate a hand value, representing a value of the best possible poker hand that can be formed using the cards identified by the contents of the cards field 402.

Accordingly, block 928 directs the processor circuit 52 to compare the hand values corresponding to the cards fields 402 of all players who were “in”, or more particularly, of all player session objects 142 listed in the seated field 432 having active in flag field 408 contents. Block 928 directs the processor circuit to identify the winner of the hand, or more particularly, the player session object 142 having the hand object 144 contents representing the highest poker hand. In the present embodiment, the winner is identified by comparing successive pairs of players' hands: the hand of the first player is compared to that of the second player, and the hand of the winner as between these two players is then compared to the hand of the third player, and so on, until all players' hands have been compared and a winner has been conclusively identified. To achieve this, in this embodiment block 928 cooperates with the logic of the hand object 144 and the deck object 442, to direct the processor circuit to execute a hand validation routine, as follows. The processor circuit is first directed to store an identification of the first such player session object corresponding to the first player who is seated and “in”, in the winners register 162 in the RAM 88. The processor circuit is then directed to concurrently address the second such player session object corresponding to the second player who is seated and “in”, and to compare respective hand values (generated by the processor circuit under the direction of the hand object 144 logic) representing the poker hands of the two players stored in their respective cards fields 402. If the hand value corresponding to the first player is greater than that of the second player, then the identification of the first player's player session object currently stored in the winners register 162 is left unchanged. If the hand value corresponding to the second player is greater than that of the first player, the processor circuit is directed to erase the entire contents of the winners register 162, and to store an identification of the second player's player session object in the winners register. If the hand values are equal, i.e., in the event of a tie, the processor circuit is directed to append an identification of the second player's player session object to the current contents of the winners register 162, without erasing the existing identification of the first player's player session object. Following any one of the above three possible outcomes, the processor circuit is directed to address the player session object corresponding to the third player (if any) who is seated and “in”, and to compare the hand value of the third player's player session object to the hand value of the player session object identified by the current contents of the winners register 162. As described above, the winners register contents are either left unchanged if the third player's hand value is less than that of the existing winner(s), erased and replaced with an identification of the third player if the third player's hand value is greater than that of the existing winner(s), or added to by appending an identification of the third player's player session object to the winners register contents in the event of a tie. This binary comparison process is repeated until the player session objects corresponding to all players who are seated and “in” have been addressed in this manner, at which point the winners register 162 stores an identification of the winner (or winners in the event of a tie).

Block 928 further directs the processor circuit 52 to identify the losers, by identifying all player session objects 142 that are listed in the seated field 432 and have active in flag field 408 contents, but that are not identified in the winners register 162.

Block 930 then directs the processor circuit 52 to deduct the rake from the pot, transfer the remainder of the pot to the winner (or to divide it equally among the winners in the winners register 162 in the event of a tie), and update the various contents of the hand summary table 110, the hand details table 112, the games table 106, the user game table 104 and the game object 150. In this embodiment, for each identified winner, block 930 directs the processor circuit to store further information in the hand summary record 320 generated at block 902 above, by copying the contents of the pot field 472 to the pot field 332, by copying the contents of the user ID field 380 of the winner to the winners field 336, and by storing the current time and date in the end time field 328. Block 930 also directs the processor circuit to add the contents of the pot field 472 to the total pot field 278 of the corresponding games record 260 in the games table 106.

In addition, in the present embodiment block 930 directs the processor circuit 52 to determine whether the rake flag field 428 contents are set active indicating real money is used at the table, and if so, block 930 directs the processor circuit to deduct a predefined rake percentage, such as 5% for example, from the contents of the pot field 472. The dollar amount of the percentage rake is stored in the rake field 334 of the new hand summary record 320 generated at block 902, and the dollar amount of the rake is also added to the contents of the total rake field 276 of the games record 260. The rake amount is also added to the contents of the total rake field 371 of the house values table 114, and the last update field 377 is updated accordingly.

In addition, for each winner, block 930 directs the processor circuit to generate a new hand details record 350 in a manner similar to that described above in connection with block 868, having transaction type field 360 contents equal to a value representing a win, transaction amount field 362 contents equal to the contents of the pot field 472 after subtraction of the rake, and cards field 364 and privacy flag field 368 contents undefined (it will be recalled that the winner's cards are already recorded in a separate, non-private “show” transaction hand details record 350, as discussed above in connection with block 920).

In this embodiment block 930 also directs the processor circuit 52 to add the contents of the pot field 472 to the game balance field 248 of the user game record 240 in the user game table 104 corresponding to the winner's player session object and the game object (or, in the case of a tie, to add an equal portion of the pot field contents to each game balance field of each winner), and to then clear the contents of the pot field 472.

In this embodiment, prior to clearing the contents of the pot field 472 when the pot and rake have been transferred to the winner(s) and the house, respectively, block 930 directs the processor circuit 52 to copy the contents of the pot field 472 prior to deduction of the rake (or in other words the “gross” pot rather than the pot net of the rake), to a temporary storage area (not shown) in the RAM 88, for use in automatically debiting the antes of the losers, as discussed below. Following a brief delay, block 930 further directs the processor circuit to transmit game init. information to clients 66 of all players listed in the seated field 432 and the watching field 434, representing a display of the pot sliding across the table to the seat of the winner (or equal shares of the pot sliding across the table to the seats of each winner, in the case of a tie).

In addition, in the present embodiment blocks 930, 945 and 950 then effectively configure the processor circuit 52 to select a payment process for the ante amount 58 for the subsequent or next hand of the game, in response to the performance indicator 56 indicative of performance of each player in one hand of the game. More particularly, in this embodiment block 930 effectively configures the processor circuit to prompt the player to authorize payment of the ante amount if the indicator indicates a predefined performance by the player in the one hand. More particularly still, in this embodiment the predefined performance includes either a fold or a win by the player in the one hand (the present hand). Similarly, in this embodiment block 930 configures the processor circuit to set the ante amount equal to a predefined value if the indicator indicates a predefined performance of the player in the one hand. More particularly, in this embodiment the predefined performance includes either a win or a fold by the player in the one hand.

To achieve the foregoing, in the case where the performance indicator indicates a win or a fold by the player (as identified above in connection with blocks 928 and 930), block 930 directs the processor circuit 52 to select a voluntary payment process for the winner or folder, for the ante amount for the subsequent hand. More particularly, block 930 directs the processor circuit to update the player session object 142 of the winner or folder, by setting the next ante field 414 contents equal to those of the default ante field 458, and by setting the ante flag field 410 contents equal to false, so that the winner or folder will be prompted to voluntarily ante for the next hand at the next execution of block 876.

Block 930 also directs the processor circuit 52 to set the contents of the in flag fields 408 of all player session objects in the seated field 432 false.

In this embodiment, block 945 effectively configures the processor circuit 52 to, for each hand of the game, reset the round indicator inactive if a round-terminating condition has occurred, to indicate the round has ended. In addition, blocks 945 and 950 effectively direct the processor circuit 52 to select a payment process for the ante amount for the subsequent or next hand of the game, in response to the performance indicator indicative of performance of each player in one hand of the game. More particularly, blocks 945 and 950 effectively configure the processor circuit to automatically debit the ante amount for the subsequent hand if the performance indicator indicates a predefined performance of the player in the one hand.

To achieve the foregoing, in the present embodiment, block 945 configures the processor circuit 52 to monitor the performance indicator 56 for each player of the game to determine whether the round-terminating condition has occurred. More particularly, in this embodiment blocks 945 effectively configures the processor circuit to reset the round indicator inactive if there are no losers and at least one winner of the game, or more particularly, of the hand of the game that has just been played. In this regard, it is noted that if there are no losers of the hand, and at least one winner, then the pot for the next hand will merely be the sum of the default antes for all players, and therefore, there is no reason to preclude new players from joining in at this stage of the game. Thus, in this embodiment, the absence of any losers and the presence of at least one winner is a round-terminating condition.

Upon executing block 945, it has already been established at block 921 that there is at least one winner of the hand, and therefore, it is not necessary to check this again. Accordingly, block 945 directs the processor circuit 52 to determine whether there is at least one loser of the hand, by monitoring the performance indicators 56, or more particularly, by determining whether there is at least one player session object 142 in the seated field 432 having active ante flag field 410, decided flag field 406 and in flag field 408 contents. It will be recalled that the ante flag field 410 contents of winners and folders have now been set inactive at block 930 above, and therefore, only a loser of the hand will have this combination of active flag field contents at block 945.

If the round-terminating condition is detected at block 945, i.e., if there were no losers and at least one winner of the hand, then block 946 directs the processor circuit 52 to transmit notification signals to the clients of all players identified in the seated field 432 and the watching field 434 of the game object 150, to notify all players in the room that a new round is about to commence. Block 946 then directs the processor circuit back to block 850 to reset the contents of the round-in-progress flag field 448 inactive and to commence a new round of the game.

Conversely, if at least one loser was identified at block 945, block 950 then directs the processor circuit 52 to automatically debit the ante amount 58 for the subsequent hand if the performance indicator 56 indicates a predefined performance of the player in the one hand. More particularly, in this embodiment the processor circuit is configured to automatically debit the ante amount only if the performance indicator indicates a loss by the player in the one hand. In addition, in this embodiment block 950 configures the processor circuit to automatically debit this ante amount prior to a commencement of the subsequent hand. Also in this embodiment, block 950 configures the processor circuit to automatically determine the ante amount as a function of a pot of the one hand if the indicator indicates a predefined performance of the player (which in this embodiment is a loss) in the one hand.

To achieve the foregoing, in the present embodiment, block 950 first directs the processor circuit 52 to obtain a unique hand number for the next hand, by copying the next available hand number global value from the global values table 160 to the hand number field 426 of the game object 150, and incrementing the next available hand number global value in the global values table. In this regard, the automatically debited ante is considered to be a transaction for the next hand that has not yet been played, rather than a transaction for the present hand that has just ended.

For each player session object 142 corresponding to each loser identified at block 928, block 950 then directs the processor circuit 52 to set the contents of the hand start balance 250 of the corresponding user game record 240 equal to the contents of the game balance field 248. For each such loser, block 950 then directs the processor circuit to subtract the gross pot value temporarily stored in the RAM 88 at block 930 (i.e., the amount of the pot that was just won in the present hand, prior to subtraction of the rake), from the game balance field 248 of the user game record 240 of the loser, and to add this gross pot value to the contents of the pot field 472 for the next hand.

Block 950 also directs the processor circuit 52 to transmit game init. information to all clients of all player session objects 142 listed in the seated field 432 and the watching field 434, for use by the clients in generating a display of the mandatory ante sliding across the table from the seat of each loser to the pot in the center of the table.

For each loser, block 950 also directs the processor circuit 52 to generate a new hand details record 350, to copy the newly-obtained hand number stored in the hand number field 426 to the hand number field 352, to copy the game ID field 424 contents to the game ID field 354, and to store the current time and date in the transaction time field 356. Block 950 further directs the processor circuit to copy the contents of the user ID field 380 of the loser's user session object 140 to the user ID field 358 of the newly-generated hand details record (it will be recalled that the loser's cards have already been recorded in a separate non-private “show” transaction hand details record 350, as described above in connection with block 920). Block 950 directs the processor circuit to store a value in the transaction type field 360 indicating an involuntary ante due to a loss in the previous hand, and to store the amount of the mandatory ante (i.e., the gross pot amount of the present hand that has just been won) in the transaction amount field 362.

In addition, block 950 directs the processor circuit 52 to write values to the player session object 142 of each loser, to identify the player as having lost in this hand and having already anted for the next hand that is about to begin. More particularly, block 950 directs the processor circuit to set the next ante field 414 contents equal to −1 and the ante flag field 410 contents equal to 1 (true) for each player session object 142 of each loser, so that such losers will be properly identified at block 864 of the next hand and will not be prompted to voluntarily ante a second time.

Additionally, in this embodiment block 950 further directs the processor circuit to set the contents of the in flag fields 408 of all player session objects in the seated field 432 false.

Block 960 then directs the processor circuit 52 back to block 852 to commence a new hand of the round, as described above.

Client Game Applet

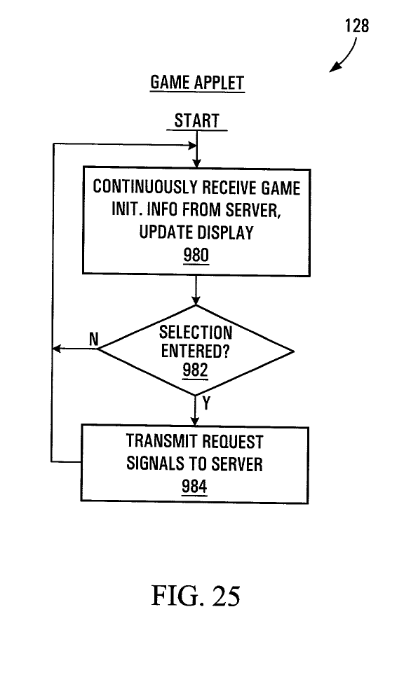

Referring to FIGS. 2, 3, 24 and 25, the game applet is shown generally at 128 in FIG. 25. Generally, the game applet is uploaded by the game server 54 to each of the clients 66 shown in FIG. 2, and configures the clients 66 to communicate with the game server 54 to enable a game to be played over the network 64.

More particularly, in this embodiment the game applet 128 directs a processor circuit of each client, such as the processor circuit 74 of the client 70 for example, to receive game status signals from the game server 54 and to communicate game decision signals to the game server, to enable the player 60 to play one hand of a game, such as the first or “present” hand described above in connection with FIG. 24, for example, and to enable the player to play a subsequent hand of the game, such as the “next” hand discussed above in connection with FIG. 24 for example, for which an ante amount for the player is automatically determined in response to performance of the player in the one hand of the game. More particularly, it will be recalled that the ante amount for a winner or folder is set to a default ante amount in the present embodiment, whereas the ante amount for the subsequent hand for a loser is set equal to the pot of the hand the loser lost. Effectively, the processor circuit 74, when configured by the game applet, acts as a means for communicating with the game server as described above, or more particularly, as a means for receiving game status signals from the game server, and as a means for communicating game decision signals to the game server.

In this embodiment, the game applet 128 begins with a first block 980 of codes, which directs the processor circuit 74 to continuously receive game status signals, or more particularly the game init. signals described above in connection with the game object game routine, transmitted by the game server 54 over the network 64, and to continuously update a display of the game on a display device such as a monitor of the client 70 shown in FIG. 2, for example. In this embodiment, the game server 54 actively pushes such game init. information to each of the clients 66 over the network 64 over the unencrypted channel. The display of the game may include a display of a poker hand in progress, for example, and may also include one or more commands or selections, such as a command button displayed on the screen for example, that the user may actuate in order to cause the processor circuit 74 of the client 70 to transmit a command or selection or request to the game server 54. In the present embodiment, such commands include all of the commands and selections discussed earlier herein, such as requests to join a game, requests to be seated at a game or placed on a waiting list, requests to transfer funds into or out of the game server 54 or into or out of a room, ante/sit out decisions, requests for encrypted transmission of cards, in/fold decisions, and other commands or selections discussed herein, for example. Alternatively, other commands may be added or substituted.

Block 982 directs the processor circuit 74 to determine whether user input signals, such as those produced in response to manipulation of an input device such as a mouse or keyboard for example, have been received at the client 70, representing user selection of such a command or request. If so, block 984 directs the processor circuit 74 to communicate to the game server 54, via the network 64, game decision signals representing the selection or request, for response by the processor circuit 52 of the game server. In this embodiment, such game decision signals are communicated to the game server via the encrypted channel.

Following execution of blocks 982 or 984, the processor circuit 74 is directed to continue processing at block 980 to continuously receive game init. information from the game server 54 and update the display of the game in response thereto.

Effectively, the game applets 128 of the present embodiment configure the clients 66 to act as slaves to the game server 54, which actively pushes game init. information including command or selection options to the clients 66 over unencrypted channels, and which responds to signals from the clients representing selection of the options.

Alternatives

Although a 2-card poker game embodiment has been described above, alternatively, as noted, other types of games, involving other numbers of cards, may be substituted if desired.

Similarly, although a single ante/sit out decision and a single in/fold decision have been described above in the context of the preferred embodiment, alternatively, other decision types may be added or substituted, if desired. For example, one or more betting rounds may be interposed between the ante/sit out decision and the in/fold decision. In such a case, one or more additional cards may be dealt between betting rounds, if desired.

Additionally, rather than prompting a winner of one hand to voluntarily ante for a subsequent hand, the ante amount for the winner of the one hand may be waived for the subsequent hand if desired. In this regard, referring back to FIGS. 3 and 24, block 930 may instead configure the processor circuit to waive payment of the ante amount for the subsequent hand if the indicator indicates a predefined performance of the player in the one hand, or more particularly, a win by the player in the one hand. This may be achieved by setting the next ante field 414 contents equal to zero, for example. In this case, during the next hand, a modified block 876 may direct the processor circuit 52 to respond to such next ante field contents by automatically setting the decided flag field 406 contents of the winner active, rather than prompting the winner to ante.

As noted, although a network embodiment, or more particularly, an Internet embodiment, has been described for illustrative purposes, alternatively, embodiments of the invention may be implemented using other technologies. For example, other networks, such as public or private local- or wide-area networks, may be substituted. Similarly, wireless communications such as satellite communications, or wired communications such as cable networks for example, may be employed. Alternatively, any other type of digital media may be substituted if desired, for example.

More generally, while specific embodiments of the invention have been described and illustrated, such embodiments should be considered illustrative of the invention only and not as limiting the invention as construed in accordance with the accompanying claims.

What is claimed is:

1. A gaming method comprising automatically determining, in response to a performance indicator indicative of performance of a player in one hand of a game, an ante amount for said player for a subsequent hand of said game.

2. The method of claim 1 further comprising permitting said player to play said one hand only if said player has available funds of at least a maximum possible value of said ante amount for said subsequent hand.

3. The method of claim 2 wherein permitting comprises calculating said maximum possible value of said ante amount for said subsequent hand.

4. The method of claim 3 wherein permitting further comprises comparing said maximum possible value to account record contents indicative of said available funds of said player.

5. The method of claim 1 further comprising selecting a payment process for said ante amount in response to said indicator.

6. The method of claim 5 wherein selecting comprises automatically debiting said ante amount for said subsequent hand if said indicator indicates a predefined performance of said player in said one hand.

7. The method of claim 6 wherein selecting comprises automatically debiting said ante amount only if said performance indicator indicates a loss by said player in said one hand.

8. The method of claim 6 wherein automatically debiting comprises automatically debiting said ante amount prior to a commencement of said subsequent hand.

9. The method of claim 5 wherein selecting comprises prompting said player to authorize payment of said ante amount if said indicator indicates a predefined performance by said player in said one hand.

10. The method of claim 9 wherein selecting comprises prompting said player if said indicator indicates a fold by said player in said one hand.

11. The method of claim 9 wherein selecting comprises prompting said player if said indicator indicates a win by said player in said one hand.

12. The method of claim 5 wherein selecting comprises waiving payment of said ante amount if said indicator indicates a predefined performance of said player in said one hand.

13. The method of claim 12 wherein selecting comprises waiving said payment if said indicator indicates a win by said player in said one hand.

14. The method of claim 1 wherein automatically determining comprises automatically determining said ante amount as a function of a pot of said one hand if said indicator indicates a predefined performance of said player in said one hand.

15. The method of claim 14 wherein automatically determining comprises setting said ante amount equal to said pot if said indicator indicates a loss by said player in said one hand.

16. The method of claim 1 wherein automatically determining comprises setting said ante amount equal to a predefined value if said indicator indicates a predefined performance of said player in said one hand.

17. The method of claim 16 wherein setting comprises setting said ante amount equal to said predefined value if said indicator indicates a win by said player in said one hand.

18. The method of claim 16 wherein setting comprises setting said ante amount equal to said predefined value if said indicator indicates a fold by said player in said one hand.

19. The method of claim 1 further comprising receiving a request from a new player to join said game.

20. The method of claim 19 further comprising permitting said new player to join said game only when a round of said game has ended.

21. The method of claim 20 further comprising maintaining a round indicator indicative of whether said round of said game is in progress.

22. The method of claim 21 wherein maintaining said round indicator comprises setting said round indicator active at a commencement of a first state of said game.

23. The method of claim 22 wherein maintaining further comprises, for each hand of said game, resetting said round indicator inactive if a round-terminating condition has occurred, to indicate said round has ended.

24. The method of claim 23 further comprising monitoring said performance indicator for each player of said game to determine whether said round-terminating condition has occurred.

25. The method of claim 24 wherein resetting comprises resetting said round indicator inactive if there are no losers and at least one winner of the game.

26. The method of claim 1 further comprising generating and storing said performance indicator.

27. The method of claim 26 wherein generating comprises generating said indicator to indicate a fold by said player in response to a fold command received from said player.

28. The method of claim 1 wherein automatically determining comprises automatically determining, in response to a plurality of performance indicators indicative of performance of a plurality of respective players in one hand of a game, an ante amount for each of said players for a subsequent hand of said game.

29. The method of claim 28 further comprising simultaneously notifying said players of in decisions and fold decisions of all of said players.

30. A gaming method comprising receiving game status signals from a game server and communicating game decision signals to said game server, to enable a player to play one hand of a game and to enable said player to play a subsequent hand of said game for which an ante amount for said player is automatically determined in response to performance of said player in said one hand of said game.

31. A gaming apparatus comprising a processor circuit configured to automatically determine, in response to a performance indicator indicative of performance of a player in one hand of a game, an ante amount for said player for a subsequent hand of said game.

32. The apparatus of claim 31 wherein said processor circuit is configured to permit said player to play said one hand only if said player has available funds of at least a maximum possible value of said ante amount for said subsequent hand.

33. The apparatus of claim 32 wherein said processor circuit is configured to calculate said maximum possible value of said ante amount for said subsequent hand.

34. The apparatus of claim 33 wherein said processor circuit is configured to compare said maximum possible value to account record contents indicative of said available funds of said player.

35. The apparatus of claim 31 wherein said processor circuit is configured to select a payment process for said ante amount in response to said indicator.

36. The apparatus of claim 35 wherein said processor circuit is configured to automatically debit said ante amount for said subsequent hand if said indicator indicates a predefined performance of said player in said one hand.

37. The apparatus of claim 36 wherein said processor circuit is configured to automatically debit said ante amount only if said performance indicator indicates a loss by said player in said one hand.

38. The apparatus of claim 36 wherein said processor circuit is configured to automatically debit said ante amount prior to a commencement of said subsequent hand.

39. The apparatus of claim 35 wherein said processor circuit is configured to prompt said player to authorize payment of said ante amount if said indicator indicates a predefined performance by said player in said one hand.

40. The apparatus of claim 39 wherein said processor circuit is configured to prompt said player if said indicator indicates a fold by said player in said one hand.

41. The apparatus of claim 39 wherein said processor circuit is configured to prompt said player if said indicator indicates a win by said player in said one hand.

42. The apparatus of claim 35 wherein said processor circuit is configured to waive payment of said ante amount if said indicator indicates a predefined performance of said player in said one hand.

43. The apparatus of claim 42 wherein said processor circuit is configured to waive said payment if said indicator indicates a win by said player in said one hand.

44. The apparatus of claim 31 wherein said processor circuit is configured to automatically determine said ante amount as a function of a pot of said one hand if said indicator indicates a predefined performance of said player in said one hand.

45. The apparatus of claim 44 wherein said processor circuit is configured to set said ante amount equal to said pot if said indicator indicates a loss by said player in said one hand.

46. The apparatus of claim 31 wherein said processor circuit is configured to set said ante amount equal to a predefined value if said indicator indicates a predefined performance of said player in said one hand.

47. The apparatus of claim 46 wherein said processor circuit is configured to set said ante amount equal to said predefined value if said indicator indicates a win by said player in said one hand.

48. The apparatus of claim 46 wherein said processor circuit is configured to set said ante amount equal to said predefined value if said indicator indicates a fold by said player in said one hand.

49. The apparatus of claim 31 wherein said processor circuit is configured to receive a request from a new player to join said game.

50. The apparatus of claim 49 wherein said processor circuit is configured to permit said new player to join said game only when a round of said game has ended.

51. The apparatus of claim 50 wherein said processor circuit is configured to maintain a round indicator indicative of whether said round of said game is in progress.

52. The apparatus of claim 51 wherein said processor circuit is configured to set said round indicator active at a commencement of a first state of said game.

53. The apparatus of claim 52 wherein said processor circuit is configured to, for each hand of said game, reset said round indicator inactive if a round-terminating condition has occurred, to indicate said round has ended.

54. The apparatus of claim 53 wherein said processor circuit is configured to monitor said performance indicator for each player of said game to determine whether said round-terminating condition has occurred.

55. The apparatus of claim 54 wherein said processor circuit is configured to reset said round indicator inactive if there are no losers and at least one winner of the game.

56. The apparatus of claim 31 further comprising a memory device, and wherein said processor circuit is configured to generate and store said performance indicator in said memory device.

57. The apparatus of claim 56 wherein said processor circuit is configured to generate said indicator to indicate a fold by said player in response to a fold command received from said player.

58. The apparatus of claim 31 wherein said processor circuit is configured to automatically determine, in response to a plurality of performance indicators indicative of performance of a plurality of respective players in one hand of a game, an ante amount for each of said players for a subsequent hand of said game.

59. The apparatus of claim 58 wherein said processor circuit is configured to simultaneously notify said players of in decisions and fold decisions of all of said players.

60. A gaming apparatus comprising a processor circuit configured to receive game status signals from a game server and communicate game decision signals to said game server, to enable a player to play one hand of a game and to enable said player to play a subsequent hand of said game for which an ante amount for said player is automatically determined in response to performance of said player in said one hand of said game.

61. A gaming apparatus comprising:
a) means for associating with a player, a performance indicator indicative of performance of said player in one hand of a game; and
b) means for automatically determining an ante amount for said player for a subsequent hand of said game, in response to said indicator.

62. The apparatus of claim 61 further comprising means for permitting said player to play said one hand only if said player has available funds of at least a maximum possible value of said ante amount for said subsequent hand.

63. The apparatus of claim 61 further comprising means for selecting a payment process for said ante amount in response to said indicator.

64. The apparatus of claim 63 wherein said means for selecting comprises means for automatically debiting said ante amount for said subsequent hand if said indicator indicates a predefined performance of said player in said one hand.

65. The apparatus of claim 64 wherein said means for selecting comprises means for automatically debiting said ante amount only if said performance indicator indicates a loss by said player in said one hand.

66. The apparatus of claim 64 wherein said means for automatically debiting comprises means for automatically debiting said ante amount prior to a commencement of said subsequent hand.

67. The apparatus of claim 63 wherein said means for selecting comprises means for prompting said player to authorize payment of said ante amount if said indicator indicates a predefined performance by said player in said one hand.

68. The apparatus of claim 61 wherein said means for automatically determining comprises means for automatically determining said ante amount as a function of a pot of said one hand if said indicator indicates a predefined performance of said player in said one hand.

69. The apparatus of claim 68 wherein said means for automatically determining comprises means for setting said ante amount equal to said pot if said indicator indicates a loss by said player in said one hand.

70. The apparatus of claim 61 wherein said means for automatically determining comprises means for setting said ante amount equal to a predefined value if said indicator indicates a predefined performance of said player in said one hand.

71. The apparatus of claim 61 further comprising means for receiving a request from a new player to join said game.

72. The apparatus of claim 71 further comprising means for permitting said new player to join said game only when a round of said game has ended.

73. The apparatus of claim 61 further comprising means for generating and storing said performance indicator.

74. The apparatus of claim 61 wherein said means for automatically determining comprises means for automatically determining, in response to a plurality of performance indicators indicative of performance of a plurality of respective players in one hand of a game, an ante amount for each of said players for a subsequent hand of said game.

75. The apparatus of claim 74 further comprising means for simultaneously notifying said players of in decisions and fold decisions of all of said players.

76. A gaming apparatus comprising means for receiving game status signals from a game server and means for communicating game decision status signals to said game server, to enable a player to play one hand of a game and to enable said player to play a subsequent hand of said game for which an ante amount for said player is automatically determined in response to performance of said player in said one hand of said game.

77. A computer-readable medium storing codes for directing a processor circuit to automatically determine, in response to a performance indicator indicative of performance of a player in one hand of a game, an ante amount for said player for a subsequent hand of said game.

78. A computer-readable medium storing codes for directing a processor circuit to receive game status signals from a game server and communicate game decision signals to said game server, to enable a player to play one hand of a game and to enable said player to play a subsequent hand of said game for which an ante amount for said player is automatically determined in response to performance of said player in said one hand of said game.

79. A signal comprising a code segment for directing a processor circuit to automatically determine, in response to a performance indicator indicative of performance of a player in one hand of a game, an ante amount for said player for a subsequent hand of said game.

80. A signal comprising a first code segment for directing a processor circuit to receive game status signals from a game server and a second code segment for directing said processor circuit to communicate game decision signals to said game server, to enable a player to play one hand of a game and to enable said player to play a subsequent hand of said game for which an ante amount for said player is automatically determined in response to performance of said player in said one hand of said game.
